(19) United States
(12) Patent Application Publication
(10) Pub. No.: US 2008/0005103 A1
(43) Pub. Date: Jan. 3, 2008

(54) Intellectual property search, marketing and licensing connection system and method

(75) Inventors: Paul L. Ratcliffe, Ashburn, VA (US); Cory J. Sorice, Towson, MD (US); Steven Ivan Walk, Aberdeen, MD (US)

Correspondence Address: Invequity, LLC;(Attn: Paul L. Ratcliffe, Esq.), 42870 Meander Crossing Court, Ashburn, VA, 20148, US

(73) Assignee: Invequity, LLC

(21) Appl. No.: 11/808,357

(22) Filed: Jun. 8, 2007

Related U.S. Application Data
(60) Provisional application No. 60/811,767, filed on Jun. 8, 2006.
(60) Provisional application No. 60/815,523, filed on Jun. 21, 2006.
(60) Provisional application No. 60/836,569, filed on Aug. 9, 2006.
(60) Provisional application No. 60/898,374, filed on Jan. 30, 2007.

(51) Int. Cl. G06F 17/30; G06F 15/00

(52) U.S. Cl. 707/5; 715/517; 707/E17.017

(57) ABSTRACT

An intellectual property information search and technology marketing and licensing connection platform is provided. The present invention provides new and valuable information and connections for technology marketing and connections in a web accessible format for registered and non-registered users. Marketing is based on keywords, user actions, search results and other factors. Dynamic patent status determination is integrated into the system and is displayed and used for search result filtering and relevancy. User actions and input are also factors for document relevancy and ranking. The system also provides an improved user interface for reviewing intellectual property information with optimized image size, selectable text, and improved navigation.

This application claims the benefit of: (1) U.S. Provisional Patent Application 60/811,767 filed on Jun. 8, 2006; (2) U.S. Provisional Patent Application 60/815,523 filed on Jun. 21, 2006; (3) U.S. Provisional Patent Application 60/836,569 filed on Aug. 9, 2006; and (4) U.S. Provisional Patent Application 60/898,374 filed on Jan. 30, 2007, the entirety of each of which are incorporated herein by reference.

### FIELD OF THE INVENTION

The present invention relates to the field of lead generation and marketing, data search, and licensing. Specifically, the present invention relates to the generation of potential licensing leads through use of a data search related to technology and intellectual property data, as well as the storage, management, retrieval and multi-party access of the data.

### BACKGROUND OF THE INVENTION

The need for users to search and review intellectual property documents, such as patents, is well known. Current systems for searching and reviewing intellectual property documents primarily use text based analytics alone. Further, current systems provide the search results in list form typically showing the title of the document as a hyperlink. Some systems open to the internet (e.g. without a pass code or registration required) make images of the documents (patents) available as a separate link such that a user must first view the text to obtain the image link.

However, what is needed is a system which allows users, over a communication network or the internet, to employ text based searching while displaying the search results in a format that allows the user to see both text and image data and navigate quickly through the results in a format open to the internet for broader ad and text based search engine relevance. Still further, what is needed is an open system to allow users to identify technology relevant patents and be able to identify patents which are available for license, information to initiate or contact the licensor and ways to communicate anonymously. Additionally, the system can be used as informational pages about all aspects of the patents to allow inventors, companies, law firms and other entities to link to and from the patents so that those searching on the system have the ability to find, review information, and contact one another for opportunities.

### SUMMARY OF INVENTION

Accordingly, the present invention provides a system which overcomes the obstacles described above by providing a system and method for technology and intellectual property data search and document retrieval in a form optimized for user review and internet spiders while enabling technology owners to effectively market their technology to users and enable users to connect to with technology owners. The system is for use over any network connection although it is ideally suited for use over the World Wide Web. Additionally, the present invention is directed to a system which allows users to identify patents, either within their search or technology search area, which are available for license or sale as well as a system to anonymously or personally contact the licensors. Additional features and advantages of the invention will be set forth in the description which follows, and in part will be apparent from the description, or may be learned by practice of the invention. It is to be understood that both the foregoing general description and the following detailed description are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a system diagram of the present invention;

FIG. 2 is a representative screen capture of the Quick Search page of the system of the present invention;

FIG. 3 is a representative screen capture of the Advanced Search page of the system of the present invention;

FIG. 4 is a representative screen capture of a search results page of the system of the present invention;

FIG. 5 is a representative individual document or patent page of the system of the present invention;

FIG. 6 is a representative screen capture of a current folder page of the system of the present invention;

FIG. 7 is a representative screen capture of a list of documents or patents within a saved folder page of the system of the present invention;

FIG. 8 is a representative screen capture of a list of saved folders page of the system of the present invention;

FIG. 9 is a representative screen capture of a bulk document or patent upload page of the system of the present invention;

FIG. 10 is a representative screen capture of a bulk document or patent upload results page of the system of the present invention;

FIG. 11 is a representative screen capture of a tagging or keyword feature related to a document or patent page of the system of the present invention;

FIG. 12 is a representative screen capture of a technology highlights page of the system of the present invention;

FIG. 13 is a representative screen capture of a technology owner's personalized main page of the system of the present invention;

FIG. 14 is a representative screen capture of a technology detail page of the system of the present invention;

FIG. 15 is a representative screen capture of a technology owner's ad supported generic page of the system of the present invention;

FIG. 16 is a representative screen capture of an ad supported technology detail page of the system of the present invention;

FIG. 17 is a representative screen capture of a technology search page of the system of the present invention;

FIG. 18 is a representative screen capture of a technology owner sign up page of the system of the present invention;

FIG. 19 provides a process flowchart of a dynamic status determination process of the present invention;

FIG. 20 provides a flowchart of a dynamic status determination process of the present invention which includes a status weighting factor;

FIG. 21 provides a flowchart of an alternative process for dynamic status determination of the present invention;

FIG. 22 provides a flowchart of an alternative process for dynamic status determination of the present invention which includes a status weighting factor; and

FIG. 23 provides a process flowchart of the search relevancy process of the present invention.

### DETAILED DESCRIPTION

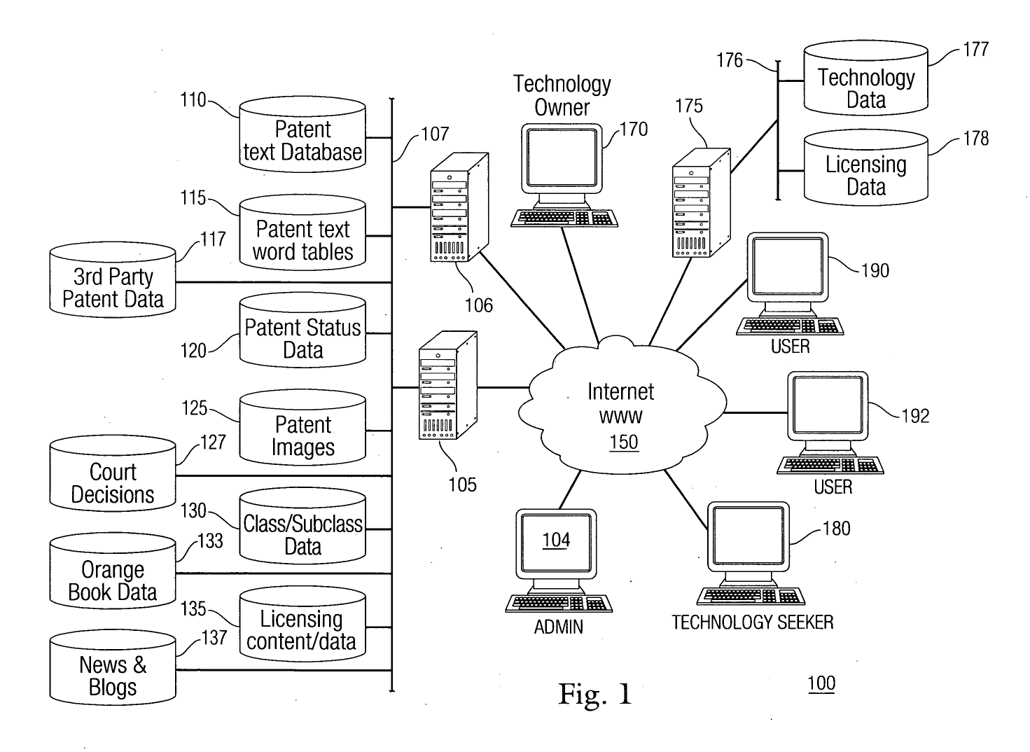

The system of the present invention will now be described in conjunction with FIGS. 1-23. The present invention provides a system which overcomes the obstacles described above by providing a system with a system and method for improved patent or document searching, reviewing, saving, accessing, and overall patent document research and management combined with a connected platform for technology marketing and connections to licensing information and points of contact.

As seen in FIG. 1, the system 100 includes a server 105 which hosts a site or service allowing users through the user of computers or terminals 190, 192 to access data through the World Wide Web 150. The server 105 is connected to or communicates with various databases through a communication line 107. One or more additional servers 106 may be used as a redundant or supplementary server for high traffic or demand periods, for maintenance or down times, or for hosting additional sites or services while still accessing the various databases. The databases included in the system 100 may include a patent text database 110, a patent text word tables 115, 3^{rd} party patent data 117, patent status data 120, patent images and documents 125, court decisions and legal data 127, patent classification and categorization data 130, Orange book and other topical related data 133, technology marketing and licensing content data 135, and news, blog and product related data 137.

In addition to users 190, 192, the system may also be used or accessed by technology owners 170, technology seekers 180 and administrators 104. In a preferred embodiment, users 190, 192, and technology seekers 180 use the website hosted on server 105 to search and access the various patent and technology related databases. The patent and technology data contained with the various databases, the various search and related technologies of the system and the manner in which it will be displayed will be described in more detail below. However, the system 100 provides an improved patent and technology data search and review website. In addition, the system 100 provides technology enabling technology owners 170 the ability to list and market their technology while enabling users 190, 192 and technology seekers 180 the ability to connect directly (or indirectly) to a point of contact (like a licensing manager).

The technology owner 170 may have their own server 175 which hosts their own website and/or data related to their technology. The technology owner's server 175 may be connected via communication line 176 to one or more databases which may contain data such as a technology database 177 and/or licensing data 178 related to that owner's technology. All of some of this information may be replicated within the licensing content database 135 in communication with servers 105, 106.

In a preferred embodiment, the system 100 provides an internet based patent document, or other image and text based document, research system or website which allows and displays both image and text based information in a user friendly format. Both images and test would employs a unique combination of both patent images sized for proper viewing on standard monitor display settings as well as text data in a format ideally suited for the internet. The system 100 also enables technology owners 170 to identify their technology and patents which are available for sale or license to be identified and marketed within the system 100, directly on each available patent in the system 100 as it is being displayed, as well as marketed through the system 100 allowing users 190, 192 and technology seekers 180 who are searching patents to easily identify which patents are available for licensing. Users can also search technology that is available for licensing or sale without the search being patent based.

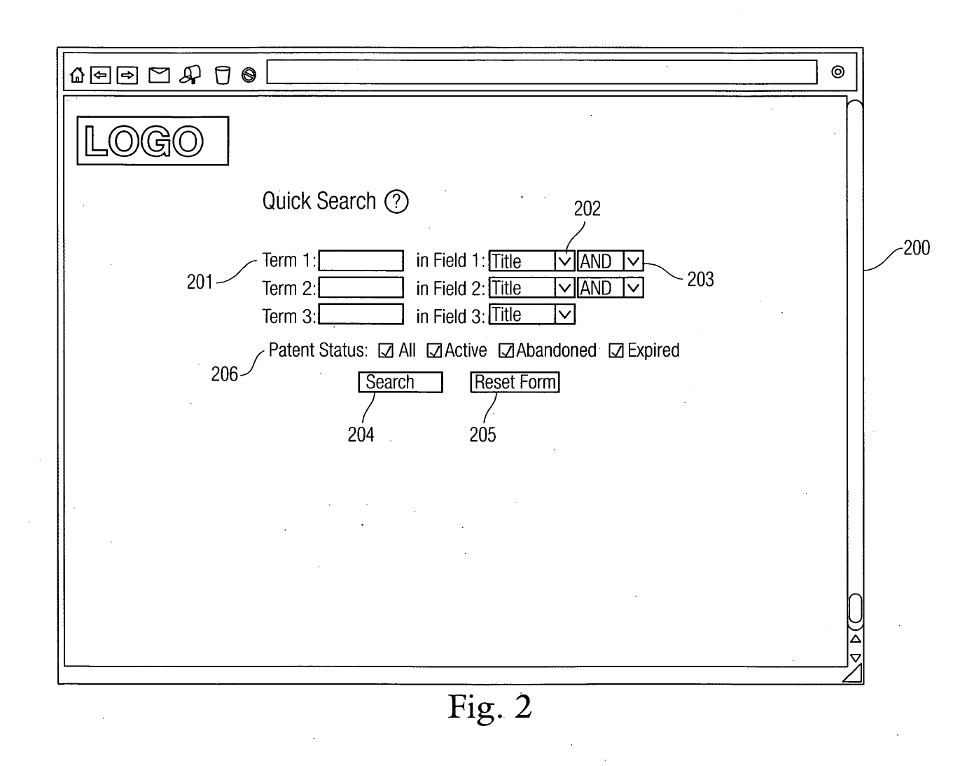

As seen in FIGS. 2-11, the patent and document search function can be illustrated through various illustrative screen captures of pages of the system of the present invention. FIG. 2 provides an illustrative screen capture of a quick or basic search function of the system. The screen capture 200 displays various fields for searching and allows a user to input key terms in box 201 and select a field in drop down menu 202. Additional terms and fields can be added through use of an operator available through drop down menu 203. After the user enters the terms and fields the user may hit return of the search button 204 to run the search. The search will access the various databases connected to the system and provide search results. Search terms are primarily assessed against terms in the patent text word tables 115 or patent text database 110. The user may reset the form through button 205. Additionally, the status of each patent within the system is determined and can be used as a filter through use of the patent status filter 206.

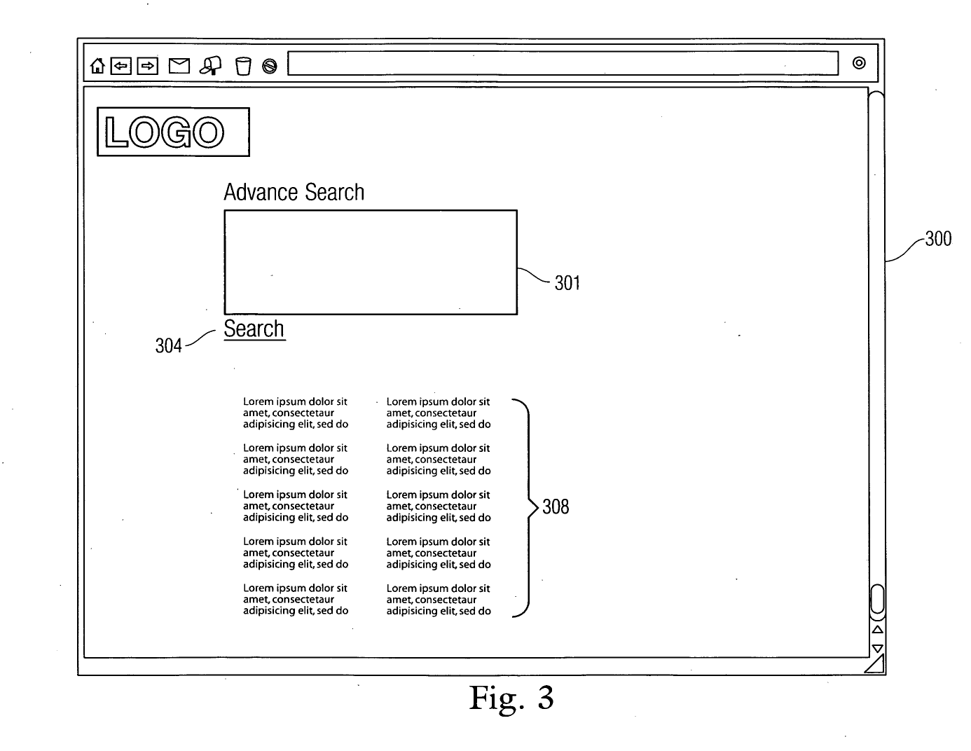

FIG. 3 provides an illustrative screen capture of an advanced search function of the system. The screen capture 300 displays a large window 301 for users to input various search terms and the fields or field codes to be searched. The field codes, names and descriptions are generally described in section 308. After the user enters the search terms and the field codes in window 301 the user selects the Search button 304 to have the system run the search. Once again, the search request is sent through the World Wide Web to a server 105, 106 (FIG. 1) where the terms are searched through the various databases providing search results.

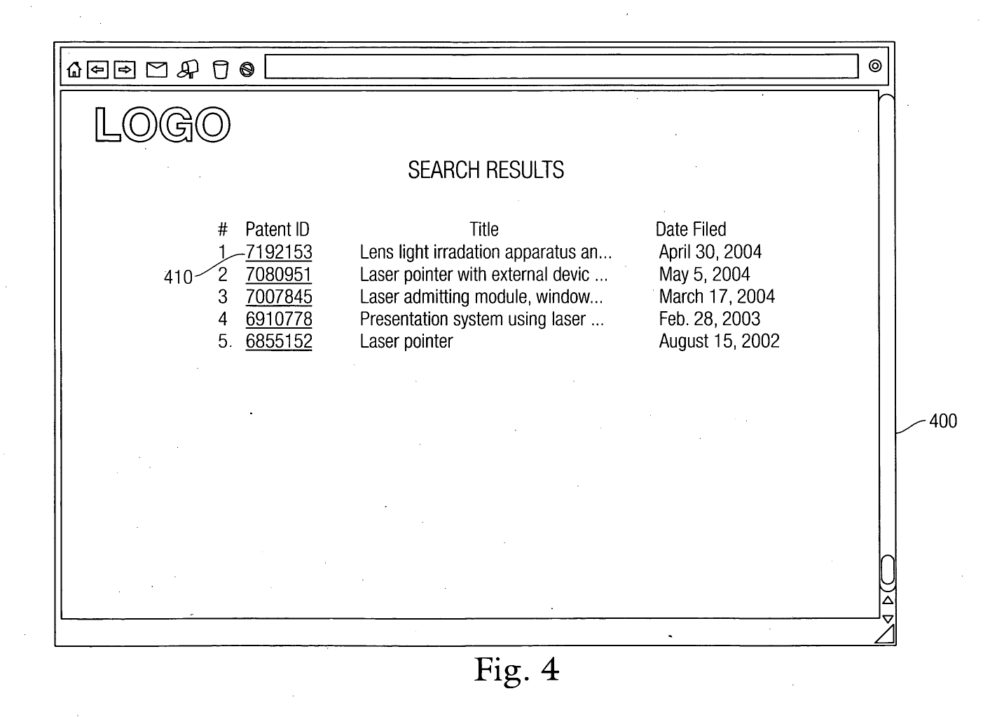

FIG. 4 provides an illustrative screen capture of a search results page of the system. The screen capture 400 displays various fields related to each document or patent related to the search query which may include, identification number, title, data filed, and any other field within the database related to the documents. The document or patent identification number 410 for each patent is displayed as a link which enables the user to select that document and see detailed information and images for that patent.

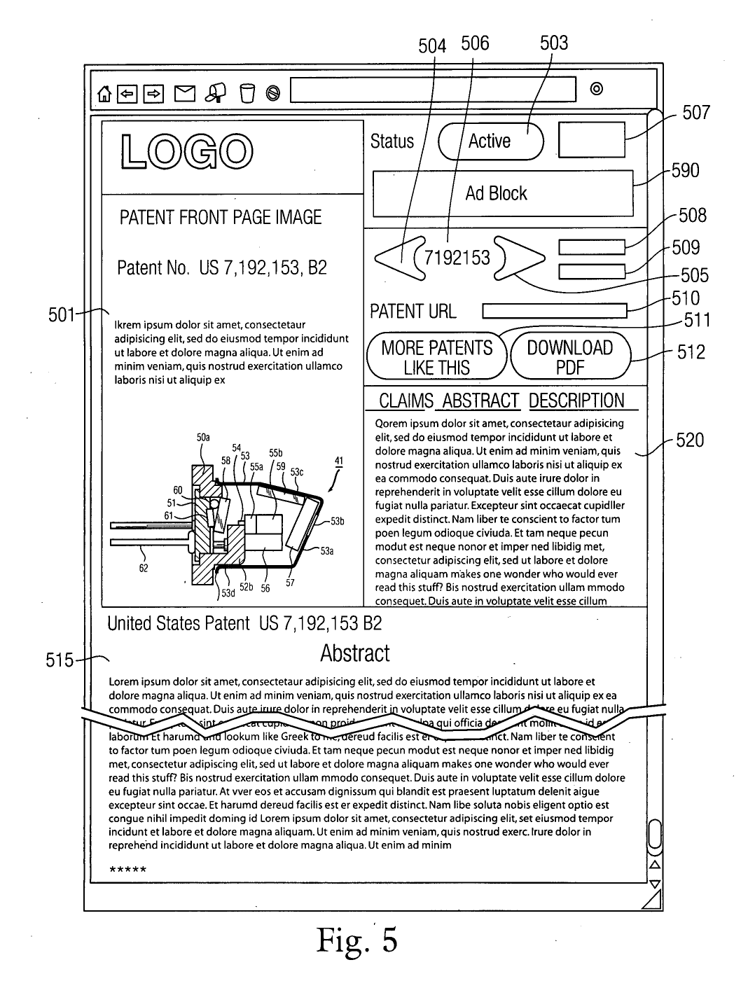

FIG. 5 provides an illustrative screen capture of an individual patent page of the system. In the preferred embodiment the screen capture 500 displays the front page 501 of the patent in a size suited for readability and proper display on the various common display settings. The image could be a jpg, gif, pdf or other format. The images is ideally sized, cropped, and converted for display on common monitors and display settings as well as converted into a format suitable for rapid transmission over the internet. The system has user selectable image sizes based on their monitor and display settings. However, the system could also read and determine display settings and establish the optimal image size to display to enable the user to see the text and image on one screen view with the need for scrolling or excessive scrolling. Common monitor sizes include 14 inch, 17 inch, and 20-21 inch monitors with bigger monitors being used more frequently. Common display settings include: 1024×768; 1280×102; 1280×800; 800×600; 1152×864; 1680×1050; 1440×900; 1600×1200; 1400×1050; 1920×1200; 1280×768; and 1280×960. Other display settings are also widely used. The four primary display settings used today are: 1024×768; 1280×102; 1280×800; and 800×600.

For users with display settings of 1024×768: the range of image sizes for the front page image displayed in window 501 may vary from a height of 500-700 pixels by a width of 300-500 pixels. The optimal image size based on user testing is approximately 625×409 pixels. A larger image could be used but would require more scrolling than necessary. A small image could be used but the text on the image would likely be illegible.

For users with display settings of 1280×1024: the range of image sizes for the front page image displayed in window 501 may vary from a height of 700-900 pixels by a width of 430-630 pixels. The optimal image size based on user testing is approximately 800×532 pixels. A larger image could be used but would require more scrolling than necessary. A small image could be used but the text on the image would likely be illegible.

For users with display settings of 1280×800: the range of image sizes for the front page image displayed in window 501 may vary from a height of 700-900 pixels by a width of 430-630 pixels. The optimal image size based on user testing is approximately 800×532 pixels. A larger image could be used but would require more scrolling than necessary. A small image could be used but the text on the image would likely be illegible.

For users with display settings of 800×600: the range of image sizes for the front page image displayed in window 501 may vary from a height of 500-700 pixels by a width of 300-500 pixels. The optimal image size based on user testing is approximately 625×409 pixels. A larger image could be used but would require more scrolling than necessary. A small image could be used but the text on the image would likely be illegible.

As display settings change the general range for front page image sizing for optimized viewing is approximately 55-80% of the display setting with optimal settings currently 60-65% of the display setting. As monitor displays increase and display settings increase the ranges may vary.

In addition to image size on the display the image file size is also important. As discussed above, images delivered on the patent detail page are specifically sized to roughly 60-65% of the display and are small from a data file standpoint for rapid delivery. The front page image, or other images including other pages, may range in file size from 5 kB to 500 kb with the majority of images in the 15 kb to 275 kB range. The images can be gif, jpg, tiffs, pdfs, or other image file formats. Images with larger file sizes could be used but would result in slower transmission times and therefore slower page load speed resulting in slower page to page navigation and site performance. Related documents such as full tiff or pdf copies of a patent could easily exceed the file size of the images displayed on the patent detail page. The file sizes for related patent documents can range from 15 k to over 100 Meg. The system can still transfer larger files; however, the patent detail page 500 is intended for rapid delivery of optimally sized images which enable text to be placed along displayed images.

The screen capture 500 also provides a user selectable text section 520 enabling users to select the text they want to read between Claims, Abstract or Description (sometimes referred to herein as the “CAD Window”. Other fields could be selectable in conjunction with or in place of the CAD Window 520 fields displayed in FIG. 5. The selectable field text window 520 enables users to see selected text while still being able to view the front page image. The patents status is displayed in section 503 and users are able to navigate through their search results through use of the navigation buttons 504, 505. The navigation buttons 504, 505 enable the user to move forward 505 or backwards 504 through each individual patent page within the search results. The patent identification number for each patent is displayed in section 506. Further, the URL for a specific patent is displayed in section 510. Users can download the full patent document through selection of button 512 and can find more patents like this through selection of button 511. The more patents like this button 511 may run a search and/or list patents cited on the patent as well as patents which reference the patent being viewed. Additional more complex searches can be done in conjunction or as an alternative to a listing of cited and referenced by patents. Users may add an individual patent to a temporary folder through use of button 508 and can view all of the patents in the temporary folder through use of button 509. In addition to the features and elements already discussed, the screen capture 500 of the individual patent page provides all of the text for the entire patent in section 515 which is located below the .front page image window 501 and the user selectable text window 520.

Additionally, each patent page has the ability to identify if it's available for license or sale through use of the license window 507. The license window 507 displays one (1) or more messages or graphics when the user lands on the individual patent page when a patent within the database is identified as available for sale or license. The user may select or click on the licensing window 507 to initiate the technology connection process as will be discussed in more detail below.

Reviewing Search Results Using the Front Page View

Those experienced in searching and reviewing patent documents understand that text based searching provides significant benefits for identifying relevant patents. However, text based searching alone does not always identify the most relevant patents and requires the user to do extensive visual inspection of the patents. Ultimately, users must spend hours visually reading text and then selecting additional links to view patent images. The present invention improves the efficiency and time spent by users reviewing, filtering through and selecting relevant patents by providing users both text and image data on one screen or webpage 500. Allowing users to perform text based searches and then quickly review both patent text and images on one page enables users to quickly navigate through numerous patent detail pages 500 thereby reducing the number of web page loads, decreasing search and review time and increasing efficiency.

As seen in FIGS. 2-5, the present invention provides users both a search function 200, 300 as well as a patent detail page 500 display in which users can rapidly review patents, and a means 508, 509 for selecting and storing patents for later review and retrieval.

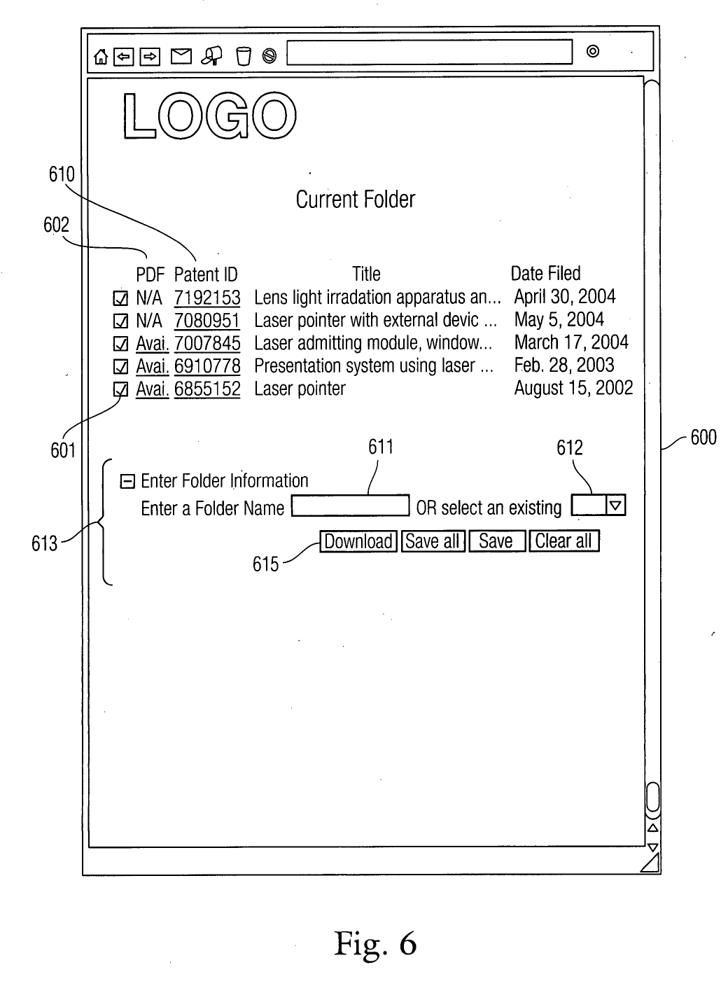

FIG. 6 provides an illustrative screen capture of the current or temporary folder view of the system. The screen capture 600 displays patents added to the current or temporary folder during a user's review of patents. The page 600 may display if a pdf document of the patent is available in column 602, the patent identification number 610, as well as title and other information. The user may select or deselect individual patents in the folder through check box 601. The list of checked patents can be saved through use of the save function 613. A saved folder name is entered into field 611 or the patents can be added to an existing folder through drop down menu 612. Users can download all the pdf documents within a folder through use of the download button 615.

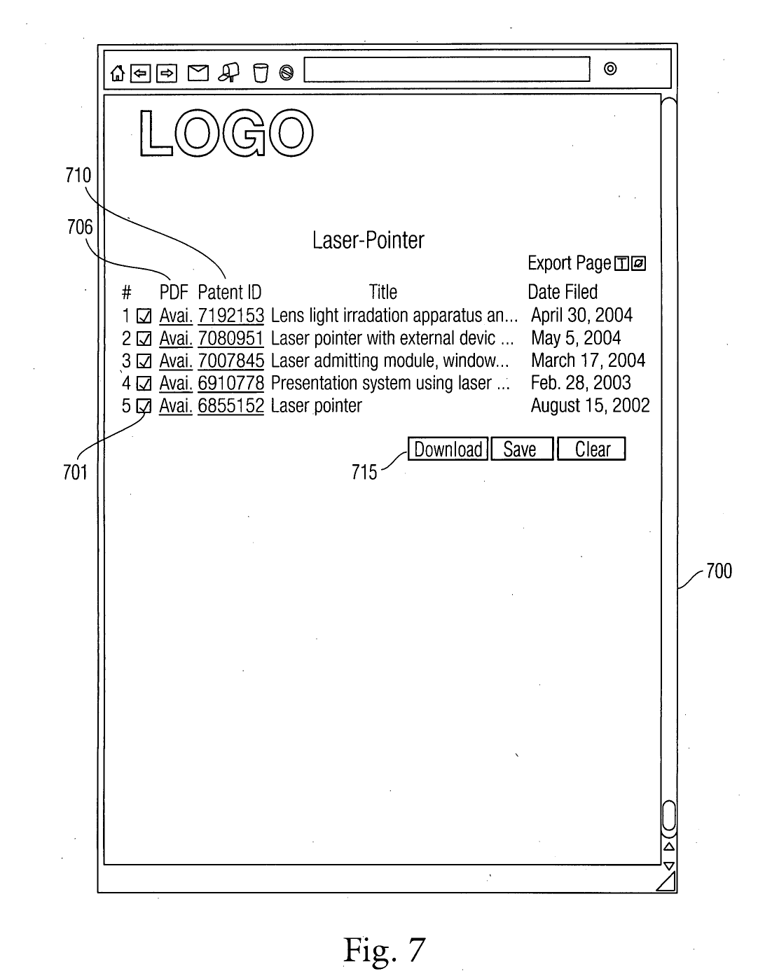

FIG. 7 provides an illustrative screen capture 700 of a saved folder view of the system. The page 700 may display if a pdf document of the patent is available in column 702, the patent identification number 710, as well as title and other information. Once again, users can download pdf documents of the patents the use of the download button 715, or delete selected patents from the folder. Users can also save selected patents within a new folder or add them to an existing folder.

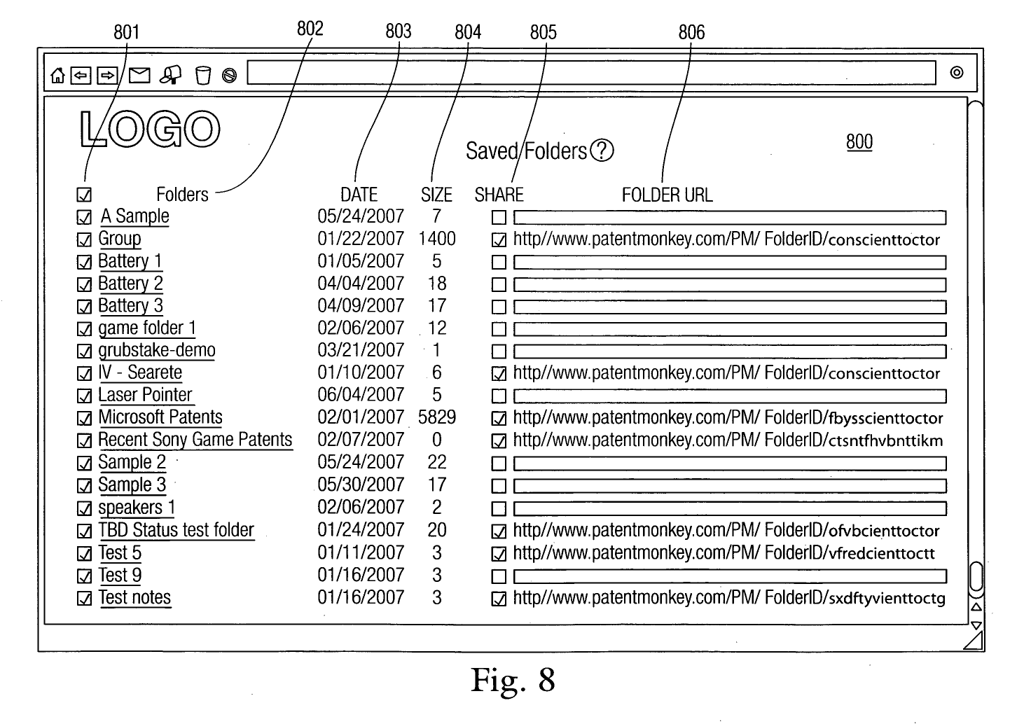

A user has the ability to save multiple folders within their account on the system. FIG. 8 provides an illustrative screen capture 800 of a users saved folders. The page 800 may display the folder names 802, the date the folder was created 803, the size or number of documents in the folder 804, if the folder is open for sharing with other users 805, and the folder URL 806. A user may delete folders by deselecting the check box 801.

Additionally, the search results may be provided in standard patent number and patent title list form. However, a primary intention of the system is to provide a website where patent images and text can be rapidly viewed in one screen over the internet or through use of the World Wide Web. Rapid user document or patent reviewing is enabled by the system which provides users their search results in a viewable format where the user sees front page images of the patents in addition to user selectable text. The display may show additional images of the patents and the text may be static, dynamic and/or scrolling.

Further, understanding the variations in screen size as well as understanding the unique nature of internet search engines, internet spiders, page relevance, and the like, present several challenging issues. The present invention provides a unique system and method which overcomes these challenges by resizing patent images for display on standard monitors and display settings. Patent images are typically sized for display on very larger screens and come in a format which provides a large data file which is problematic for rapid and sustained use and delivery over the internet of World Wide Web. The present invention provides a system and method that crops, resizes, and reformats the image data into an appropriate size and file format optimized for common monitors and display settings while marrying the images to searchable text (html or the like) to provide users an optimal document search and display system. The searchable text is configured and provided on the patent page to enable internet spiders the read, scan and index the text.

Referring back to FIG. 5, the user is also provided a navigation system 504, 505, 506 which allows the user to add patents 508 he is viewing to a saved list, to navigate forward 505 to the next patent in the search result without adding the patent to the saved list, or to navigation backward 504 through the search results. In addition, the user may select to view the search results in List form as seen in screen capture 400 which would display a number of patent attributes which include the patent number and title (though, a number of other sections of a patent, such as inventors, assignees, date of application or issuance, could also be displayed and made as options to the user). The List form may also show the user their progress through the List identifying which patents have been added to the saved list, which have been viewed as well as which ones have not been selected or not viewed. The user, from the List view, may also select any patent from the list through the linked patent identification number 410 and immediately go to the patent detail page 500 which provides an image plus text view for that document or patent. The navigation process allows users to rapidly process hundreds (or more) of patents by enabling the user to view the entire front page of the patent document in a readable format. The front page of patent provides users with an abstract, a primary image as well as other pertinent information. The user while quickly reviewing the patents can save all patents of interest to their saved list for downloading of the full patent document.

The system of the present invention also enable users to save lists of search results including a number of valuable data fields such as which patents were viewed and selected, which project, product(s), product feature(s) and/or company/client the search was done for, and the time and date of the search. Additionally, the present invention allows for the user to save such a List while in the middle of a search so the user can come back to the list at a later time. The present invention also allows the user the ability to store a multitude of searches, delete unwanted searches, download summaries or detailed information, and share searches with other users from their organization or firm, with a client, or with other users that could provide guidance. Further, the system enables users to request assistance with a search while on the system and have an expert or assistant interact with them regarding their search terms, parameters and results. Such assistance could be real time through chat or other communications such as voice over the internet (VOIP) or through email or forums.

The system and method of the present invention also enables the user to download documents for printing or saving. The downloading of multiple documents (i.e. patent documents) may require the user to download each document individually. In bulk, or in any combination thereof. Downloading may be handled by storing the documents in a user accessible online folder where they can select and choose the documents to download in any sequence and order they choose or all documents may be saved in a folder which is accessible by or sent to the user as one download (all documents within the folder). The documents may be downloaded from a centralized storage location or downloads could be shared across a peer network or other file or document downloading or file sharing systems.

In the preferred embodiment, individual patent document downloads are requested by the user sending a communication over the world wide web to server 105 or 106 which pulls the requested document from the patent images and document database 125. The document is then transmitted to the user 190, 192 by server 105 or 106. Bulk download or multiple documents within a folder are temporarily pulled from the patent images and document database 125 into a folder on server 105 or 106 and then transmitted as a folder to user 190, 192. The temporary folder may be zipped, compressed, and/or locked prior to transmitting to a user 190, 192. Further, the patent documents and patent images may be in separate databases.

The system of the present invention may make use of internet advertising which might be displayed on the various pages of the system. As an example, the patent detail page 500 includes an ad block 590 for displaying ads. Additionally, the system may require the user to pay for services either on a per download basis or for a monthly or other periodic fee, or for a one time fee. In addition to the document in digital form, additional information may be sold or included with the document. As an example, assuming the document is a patent, the user may want to download related assignment, status, and maintenance fee data at the same time they are retrieving the document. Such additional information may be added by the user, or system, and may be viewable on the search results List or on the image and text view for each document (patent) within the system.

As previously discussed, the present invention provides a document search and review system which displays both text and image data simultaneously in a format optimized for internet browsing and viewing. The text of each patent on the system may be populated on the display page in a form that can easily readable by web crawlers, spiders, or other indexing devices/programs.

The system may use various forms of advertising which will be dynamically displayed on the page. These ads may be text relevant based ads, banners, or videos. By having the document text in proper form for web crawlers to scan enables text relevant advertisement to that particular document (patent) or technology. These ads may be ‘movable’ or randomly placed to encourage clicking, or discourage automated clicking/access of the page itself or the ads. The pages will have elements that allow users to view multiple sets of data at once, be that an image and some text, multiple images, multiple sections of text, or other combinations of data. Each element may or may not be independent of each other element and the user may or may not be able to change that relationship. In addition, the system may employ or integrate more complex advertising platforms enabling individual technology owners to advertise their available technology through the various banner ads and locations on the web pages of the system. Such ads may be text relevant ads or user or IP relevant ads.

The system of the present invention will also enable the user to run or conduct text based queries. These queries, or the query or search string, can be saved for later use or for scheduling periodic runs (such as monthly) to assist the user stay up to date on relevant documents. The search results can be sent to the client via any form of electronic communication including: RSS feeds, Email, Web Pages etc.

In addition, as mentioned above, the system of the present invention will enable the user to save search results. The user might also be able to save the search results with several field identifiers. Such fields might enable an attorney or the like to save the queries and search results for a particular client. The field identifiers might include: client name or number, project or matter name or number, part name or number, or other descriptive fields. Further, the search results, queries, or downloaded documents may have various access rights enabling a user to grant access to others for review of the search and to retrieve the search results. For example, an attorney might search patents on the system of the present invention, save the search query and the results, as well as download the relevant documents into an online folder. The user could than grant access to his client to the folder to download their own version of the search result so that the client could also download a digital copy of the documents. As previously stated, the results could also include other information, such as assignment data, maintenance fee data, which could be accessed or retrieved with the downloaded documents by the user or to anyone he granted access rights. The user could grant access to more than one other user. The fields associated with the saved queries and search results could also be used to create billing or other reports such that all searches, the results, the number of downloads, the cost and other elements for a particular matter, client or part could be quickly determined.

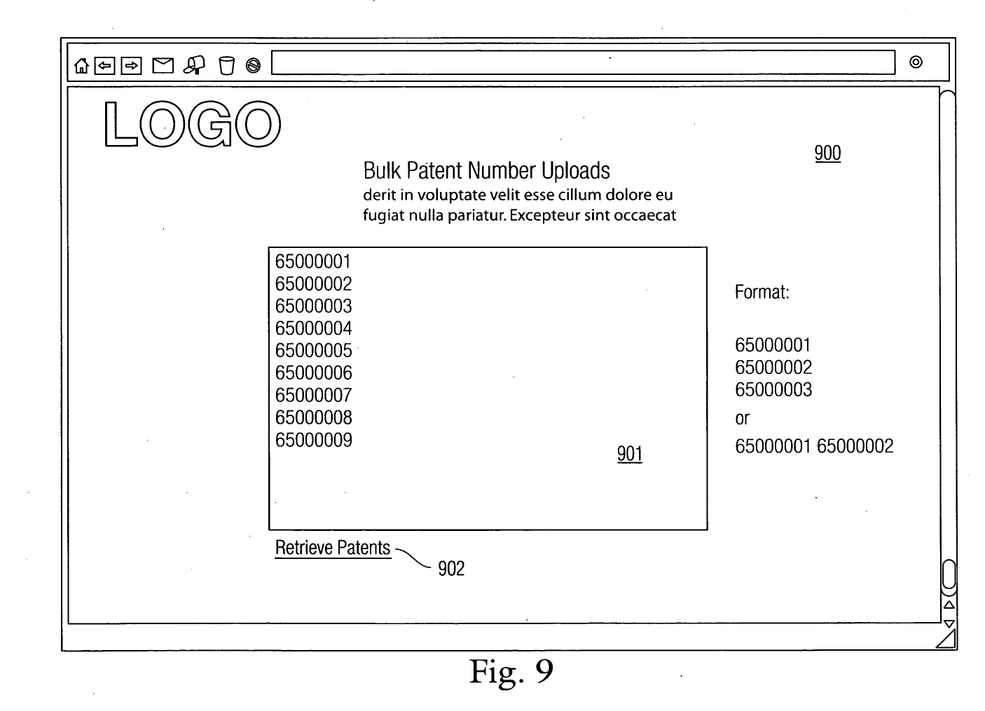

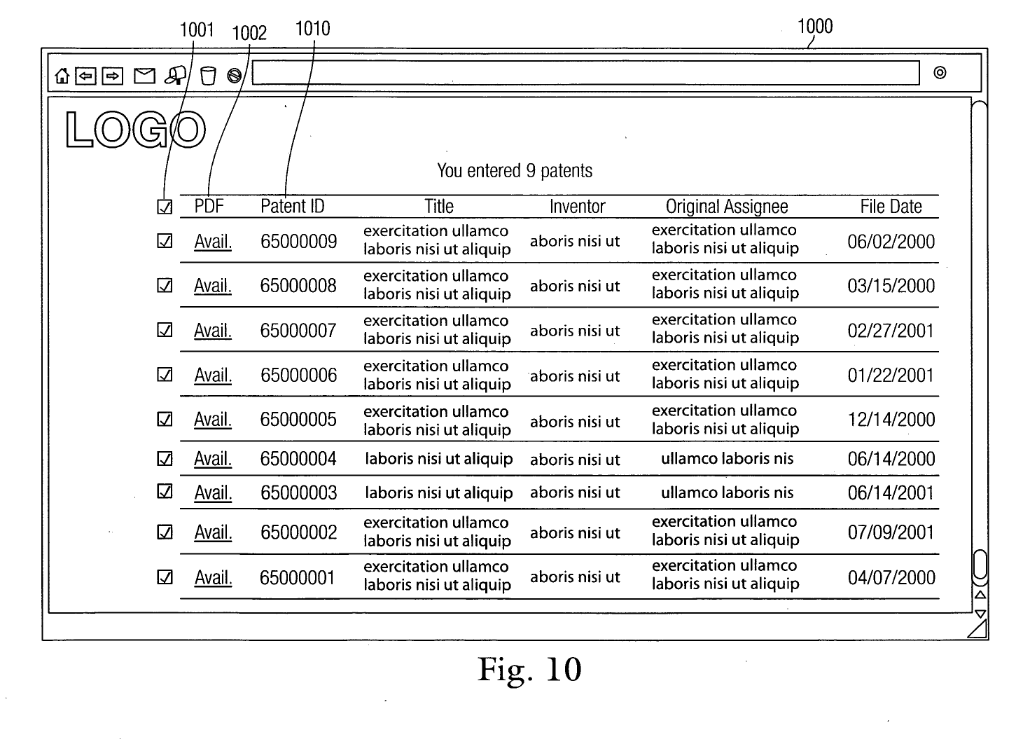

Another feature of the system is the ability to bulk upload patents from a list. FIG. 9 provides an illustrative screen capture 900 of the bulk upload entry form page of the system. The screen capture 900 displays patents in a list form within window 902 which a user enters. The user selects the retrieve patents function 902 and the system pulls the patent text, images, and any other data into a list. FIG. 10, provides an illustrative screen capture 1000 of the results list from a bulk upload utilizing the system. The screen capture 1000 displays a column of check boxes 1001 for selecting or deselecting patents within the list, a pdf available column 1002, the patent identification number column 1010 and various other data information about each patent document such as title, inventors, assignee, and file date.

Tagging

Current patents and patent applications data searching functions are highly semantic and rely upon skilled professionals to understand various technologies and concepts to fully comprehend content that is associated to each patent's scope and unique innovation. With a dramatic increase in applications and issued patents, searching for novelty, clearing features of new products and assessing patents for infringement and/or validity have become more and more time intensive requiring users to read tens if not hundreds of patents for relevance with little more than a title and classification/sub-classification as a guide to the patent's scope. A considerable problem is that the required expertise in a given technology to fully understand the nuances of certain phrases and words used continues to increase.

The system of the present invention enables users to leverage each other's knowledge, time investments and expertise for an overall website and/or data management and reporting system allowing large groups of people to add, view, search, modify and delete high level information on the whole of a patent, on sections of a patent (e.g. Abstract, Detailed Description, Assignee) or on specific phrases or words in a patent (e.g. a word or phrase in a claim). In essence, user entered information can be used as meta-data about the patent and such meta-data can be stored, searched and updated by a community of users, in a number of ways including expert moderated, expert only, all user, all invited users with a number of qualifying methods including background verification, election by peers, election by a host party or company. In the web technology arena, the term for creating such meta-data is called tagging.

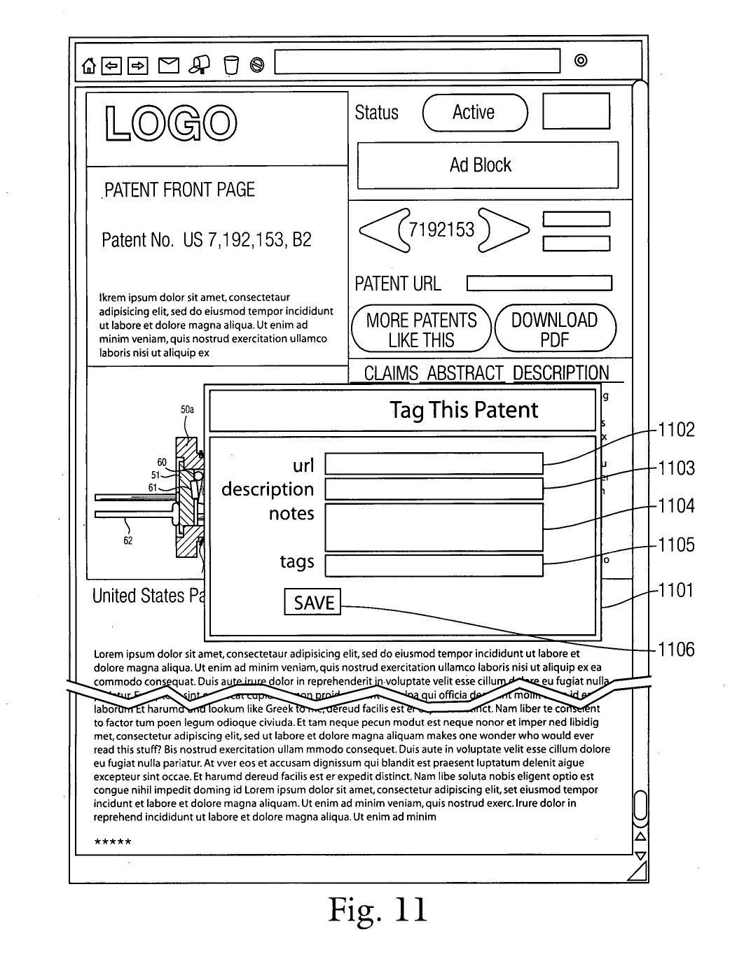

Tagging has become popular in the web arena as a new way for users to create and modify information related to a website as a whole, articles within a website or individual ideas or pictures or other content on a web site. As seen in FIG. 11, the system of the present invention provides a website or distributed and connected database driven system that allows users/members to add tag words to a patent or to particular phrases or sentences within a patent, sections of a patent, related patent documents, or patent images. The system then allows user to add, search, and view their and other's tag words, knowledge and input.

The system could include the ability for anonymous members to participate although the preferred embodiment of the system includes a membership component that would require basic user information such as name and email address for verification of the person's identity which would be required for user input such as tagging. Users could choose to use a user pseudo name as opposed to their real name. Other identification and invitation systems can be adapted to further improve the user verification if necessary such as VeriSign's identity verifier. Another embodiment would allow for groups of users (e.g. at a single law firm or company) to be able to share each other's tags or input, but to be segregated from the larger pool of public tags, and either be able to access that larger pool of tags (a partially open system), or to completely ignore a larger network's tags (a closed system).

In the preferred embodiment the system provides a website that allows a member to search and view patent information and select a whole patent, particular text or images they want to provide comments, changes or deletions to user input and then have that information stored. Comments made by members would be stored, but held anonymous so that the site host could remove abusive comments or members. In other embodiments, a member's comments could be viewed by other members or all member comments would not be stored or tracked back to a member. The benefits of tracking comments by member include: the ability to remove an entire member's comments; the ability to highlight the quality of a member's comments to other members; the ability to ascertain a member's field of expertise; the ability to ascertain a member's interests/preferences; and the ability to evaluate on a scale the quality of a member's comments (for compensation or recognition purposes).

Another element of the invention includes the pre-population of such tag words to allow for the tag word function to have relevance early in a website or distributed database's use. Such methods for creating tag words (that would then be associated to its corresponding patent) would include one or a combination of the follow: populating a reference table for common words and phrases and extracting non-conforming keywords; analyzing a text database of patent data and extrapolating a list of high potential words based on word length; creating a technical reference table using technical dictionaries and matching words to patent text for high potential tag words; use of industrial/commercial technology cross reference tables in combination with classification codes to add tag words and phrases that associate to a patent's technology application; use the above listed methods in combination with cited and referenced patent data (included in the patent) to correlate technology information beyond direct semantic searching; and use of low cost labor providing a compensation per tag word identified or per patent reviewed.

After tag words are compiled, the tags can then be associated to the appropriate related patent document and then later added to, modified or deleted by the member community ad an administrator. Additionally, methods described above can also be used to provide a verification of tag accuracy in an automated fashion to compartmentalize potential tag errors before reporting to administrators, authorities or experts for review, or to perform such tasks in an automated fashion through a series of defined rules around each potential error. Such combinations of rules are called Algorithm Boosting in the research community. Algorithm Boosting uses a combination of rules to create a master system that fits a complex set of goals than can be created or achieved using singular algorithms alone. The system of the present invention includes rules with the ability to exclude simple words and phrases (e.g. the, and) as well as combine rules for the relevance of words as related to a reference table requiring the achievement of a set relevance score, as the result of a search algorithm, prior to being included in the tag database. The tag database may be one or more fields within the a larger database such as the Patent text database 110 or the Patent Text word tables 115 or it may be a separate database within the system 100.

Tag words and/or phrases have additional benefits beyond the direct ability to search and view them in connection with patents and applications. As tags are accumulated and analyzed over a large member pool, these tags are analyzed for relevance against the underlying patent data they relate to creating a tag reference table. One technique the system can perform is to tie direct semantic correlations using word and phrases and their direct derivatives (e.g. batteries would be connected to battery), other semantic techniques are also employed allowing for thesaurus connections of words and phrases by having users review and provide positive, neutral or negative feedback that certain words and phrases match the patent text through use of a database thesaurus and software to create connections via algorithms. The algorithms estimate the probability of accuracy, or a combination whereby a software program stores and routinely analyzes word and phrase matches asking members for positive, neutral or negative feedback on the appropriateness of the tag (e.g. users could positively associate “alkaline cell” with “battery” and “batteries”).

With a tag reference table, searching can be enhanced by allowing a user or member to view and select other related words or phrases that would enhance a search. Additionally, relevance scores can also be created allowing a member to also make decisions on whether to add another search term from a tag list based on the score provided or used to sort in an order of priority, which can include one or a combination of the following: the number of times the tag is found in patent text; the number of times other members have selected that term; the number of times identified experts have selected the term; and the relevance of the term based on a relevance score calculated by an algorithm using one or a combination of factors relating to the text and images in a patent.

Images can also be tagged with words and/or phrases that would be stored in methods consistent with the above, where relating to members, but obviously not in methods relating to the association of the tag's words or phrases in combination with the text in the image. While image tagging is known, in systems such as flickr.com and riya.com, this invention would allow free association to a tag reference table related to patents in the same search function as those listed above for a broader way to search not only text of a patent, but also tags related to images. Image tagging can occur on the entirety of the image or on a specific element of an image through the ability to pick a spot or sector of the image dynamically and associate a tag to that section.

Patent Scoring

A variety of ways to provide a relevance score to generic internet searching has been developed to shorten and simplify a user's search. However, these search engines have not been oriented towards patent data and the specific technical nature that this arena requires. Various tools use semantic based analytics in an attempt to evaluate or score patents. However, these semantic based systems do not account for or allow for the integration of qualitative comments, input, or actions by users of a patent search system. Instead, known systems are limited to pure mathematical regression analysis.

The system of the present invention accounts for the actions and input of users and can pool their collective expertise to more broadly define the success or failure of a patent and/or the arguments for validity, scope, licensing and litigation or enforcement potential. Further, the present invention allows the users to use keywords to describe or tag patents which may not necessarily be in the patent text itself which is an advantage over known semantic based systems which are limited to the words within the patent itself. The system of the present invention also allows a vast array of users to provide and adjust data in the dataset dynamically through review and comments (i.e. tagging). In addition, the actions of the user can also be used to for scoring and analytic purposes. The number of pages visits, downloads, failure to download, as well as straight forward user scoring and all other functions available through the system.

Analyzing patent data is inherently contextual and highly terminology-specific within each document. Even more challenging, many critical phrases used within patent claims may not be clearly identified or defined within the patent body text making the use of these highly specific words or phrases even more problematic for pure algorithmic or automated thesaurus-based search methods. The system of the present invention incorporates both user generated data and actions as well as known techniques for analyzing patent data such as the use of statistical algorithms based on either determining quantitative valuations of patents or building thesaurus tables by analyzing patent text while allowing users to identify words or phrases that could better assist in a search.

Further, the system enables users to makes selections of a patent focused thesaurus to assist searching. Users further have the ability to conduct a search query on one or more terms and see the top words from the search results list from a word count standpoint. Users can then review the words and remove (or decrease the value) patents from the results set which contains words which render a reference less relevant to the search or increase the value of words to make those patent more relevant. Further the user would be able to conduct the search again taking into the account the words to remove (or decrease) and the words to add to the search (or increase in relevance). As an example, a user could search for the word phrase “laser pointer” in the abstract and receive a word list which indicates that other words form the search list include pen, pointer, light, emitting, diode, putter, golf, battery, etc. The user knows that he is not interested in search results relating to golf putters with lasers and could remove them from the search results list. The user could also increase the value of the word “pen” as he was specifically looking for a laser point pen. Through this function users can see other top words which might help clarify or focus their search. Users can also select words and be shown alternative words though use of the patent thesaurus or have the entire set of top words used as a sample to provide an entire sample set of related words from the patent thesaurus.

The system of the present invention also incorporate modeling techniques including Bayesian Models, Latent Class Models, Cluster Models, Dependency Models, Classifier Models and Subspace Models which in various methods attempt to correlate (or predict) preferences of a new user to another user via historical information collected by similar profiled users, as well as in some instances, being enhanced by the use of algorithms to improve areas where the member base is low and correlative data is limited.

While many of these technologies take into account using various algorithms and evaluation techniques, the system of the present invention includes: application to patent information including both text and images; the conceptual basis of including website members' tags; tracking the use and action of users which includes tracking which patents were or were not selected (where selecting the patent can be adding it to a saved list as a positive or negative search hit, or whether the patent positively selected also related to a patent document download from the system) in conjunction with a currently viewed patent as selected by other members in the community; and an evaluation of correlation as judged by members in combination with or separate from various other patent family and citation data and semantic and relevance algorithms. Other actions by the user which can also be tracked and used in the scoring and relevancy assessment include actions on a particular patent page such as tracking the time spent on a particular page, the selection of more than one view of the user selectable text in the CAD window 520, the selection by the user of the “more patents like this” button 511 as well as other user actions.

The system further makes use of member approvals or rejections to confirm algorithmic postulations (e.g. ‘patent X was suggested by other members and our search tools, was it relevant to your search?’) or regular expression content (e.g. ‘did this independent claim [identified as a regular expression within our database] meet your search?’) that-could be used as additional information related to a patent. Member feedback on these postulations through use of an automated component within the system can be used for refinement and precision of data related to a patent, not necessarily used to adjust the algorithm or regular expression format, but as a means to improve the overall data accuracy by accepting or rejecting the recommendation based on human feedback related to the patent's context and meaning.

Patents are territorial and though preference of one member may or may not correlate to the preferences of another, what is more important is to provide feedback and reporting mechanisms that allow members and anonymous users the ability to see many relevant search terms or phrases and results to efficiently and fully explore potentially relevant prior art. As a result, a fully developed patent search requires the building of a complex set of correlations and rules that are adjustable by members. This adjustment is not so much that the employed algorithms ‘learns’ and adjust, although that occurs, but the actions and collective intelligence of the member community can provide (or remove) specific searchable data points on specific patents thereby providing the system with historical action data for enhanced search results.

Further, integrated into the patent databases of the system of the present invention are sub-tables containing: member interaction and feedback to queries; tags; formulated and member modified word thesaurus tables; tracking of related patents that are selected (or not selected) by users on a system; and high frequency word or phrase combinations found in the patent text database that can be called out to users in various searching or refining functions.

The combination of the above mentioned techniques enables the system to create a large amount of exceptions in formulated algorithms, suggested thesaurus entries and high potential word/phrase combinations on a patent by patent basis. These search rules, and their exceptions, assist in subsequent searches by allowing the search query results set to be a combination of rules, including user interaction on a case by case basis, to refine the calculations used to search, view and select relevant patents for a search. Users can disagree with an algorithm(s) results set and provide contradictory information that can then be reviewed by administrators or others with the information capable of being modified, enhanced or deleted.

Early testing of the system suggests that two search methods of patents yield highly relevant patent search results and one commonly used one is highly uncorrelated. Using three or more keywords or key phrases against the Abstract, claims, or detailed description field yields highly relevant patents. However, the same level of relevancy is not obtained for searches in the title field. Interestingly, most known patent search engines use patent number and patent title as their search results page with an option to scan text after selecting the link of a title. However, none have attempted to deliver search results back based on a scoring system that prioritizes relevant patents using a combination of semantic and latent semantic search algorithms, patent interest (via historical user selections), and/or the occurrence of tag words.

While other systems attempt to use one or a number of algorithms against keywords (or synonyms) and then calculate relevance as a function of the frequency (or logarithmic frequency) of the number of times certain keywords are used it does not automatically mean a patent is more relevant. Because patent drafters are encouraged in the patent system to use unique language that is not consistently applied across multiple patents, using keywords alone is a poor method for refining patent search results. Additionally, certain sections of a patent are less important than others when considering search techniques. Other methods for extracting and highlighting keywords or phrases are to establish regular expressions formats related to sections or phrases within text using common field structure. The benefits of using regular expressions allow for the ability to identify, extract, manipulate and analyze data from multiple data sources. The system of the present invention incorporates the use of regular expressions enabling user's actions and feedback to improve the extracted data's accuracy as related to a patent's context.

The present invention also has several features for identifying highly relevant patents. One unique feature is the tracking of the document download function 512 (FIG. 5) or selected/saved frequency pattern and count. The system of the present invention is able to track and aggregate which patents are downloaded or have been selected/saved by a user with another patent in the same session and/or within the same folder. The frequency pattern and count results list provides patents which users have identified as relevant to other patents. Such a system enables new users to benefit from the searching and review history of all users in the aggregate. In addition, the frequency pattern and count result can be integrated into a semantic based combination to provide both patterns and count data in combination with user search terms. The results provide a term and relevancy list combined with a count relevancy. For example, if a user, through a search on the site, identified one patent as highly relevant they could determine the other patents most often selected and/or downloaded in combination with the identified patent and/or the patents most often selected and/or downloaded with the identified patent which also used a similar search term to that used in the user's search query. Moreover, the system can be used to aggregate tagging, downloading, selected/saved and/or page view information from a number of other patent search and tagging websites, including the USPTO itself.

Still further, the system of the present invention can track which patents had been selected or downloaded the most with a particular search term or phrase, regardless of its connection to an identified patent. For example, a user might search the terms “lithium ion” in the abstract of a patent and the results would provide the user a list of the patents ranked in order of which have been selected and/or downloaded the most, or the most within a defined time period. In addition, the results could be filtered or ranked by the most selected and/or downloads stemming from a related term in a search query (i.e. the most downloads where previous users also searched the term “lithium ion” in their search query).

In addition, the present invention integrates the user's action data with other known features including: patents referenced by or referenced to; family tree and related patents; and class/sub-class related searches. The also employs various methods to provide the user a multitude of ways to find the most relevant documents, or patents, to their related document (patent). As discussed above, the use of scoring, tagging or tag words, and frequency of selections or downloads amongst documents and related searches alone or in combination will provide the user new, enhanced, and unique methods of finding relevant documents through aggregated user data. The relevant documents, in the case of patents, can be used to assist users assess novelty, infringement, invalidating art, licensing opportunities, as well as make sound decisions regarding the payment of maintenance fees and donations.

Technology Marketing and Contact Function for Licensing

Another aspect of the present invention is for use as a platform to market technology that is available for license or sale and for connecting technology seekers with technology owners. The system can also be used by service providers to market services and to connect to those users in need of services.

The system of the present invention provides the ability for those who need technology or expertise, or for those clearing a product from potential infringement issues to easily identify if a patent is available for licensing or if a person or firm is available for work, if needed, and to contact the appropriate party. As seen in FIG. 1, the technology owner 170 may have his own server 175 for hosting his own website to display his own technology data 177 and licensing data 178 to market his technology. However, users 190, 192 do not have the time or the desire to visit thousands of technology owner's websites. Therefore, the present invention pulls together technology owners 170 providing a central platform for technology data. Now users 190, 192 can search the website hosted by server 105, 106 and search patent data and images and easily identify which patents are related to technology that is available for license or sale. User 190, 192 can also search just technology that is available through either the patent search site hosted by server 105 or through a separate website focused solely on the technology which may be hosted by server 106.

As discussed above, there is a feature 507 on each patent page 500 that identifies if a patent is available for license or sale. The feature 507 is also an active link which directs users to information about the technology as well as functionality to connect the user 190, 192 or technology seeker 180 with the technology owner 170.

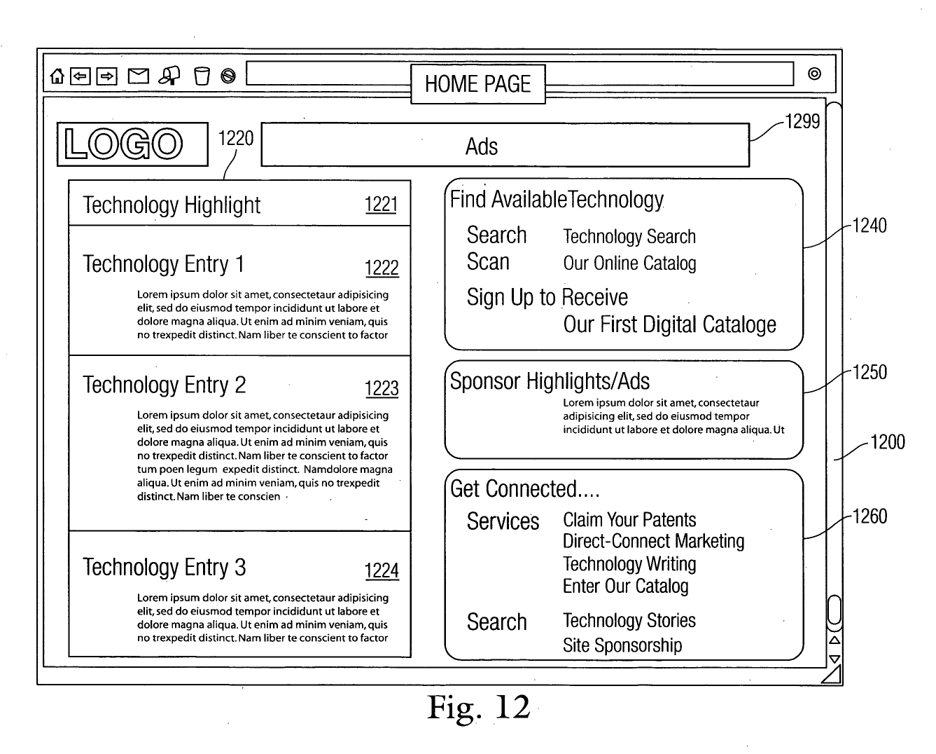

As seen in FIG. 12-18, the system of the present invention provides a system for highlighting technology, technology owners, and functionality to contact the technology owners. FIGS. 12-18 provide various illustrative screen captures of the technology portal.

FIG. 12 is an illustrative screen shot 1200 of the home page of the technology portal. The screen shot 1200 contains a technology highlight section 1220 which provides brief descriptions and write ups of highlighted technology 1221, 1222, 1223, 1224. In a preferred embodiment, the highlighted technology entries 1221, 1222, 1223, 1224 are provided in a blog style entry although they could be provided in another format. The entries could be prepared by administrators involved with the system or could be provided by the technology owners as part of a sponsored entry 1223. Each technology entry provides a brief description yet the entries 1221, 1222, 1223, and 1224 are active links which can be selected to find out more information about that technology. Also on the screen 1200 is a find available technology window 1240. The find available technology window 1240 provides active links to a technology search function, an online catalog of available technology, as well as the ability to sign up to receive digital copies of the catalog. The screen 1200 may provide windows 1299 and 1250 for advertisements and sponsors. The advertisement may be from technology owners to highlight their available technology. The advertisements may be placed by a 3^{rd} party advertising platform or may use a platform or software within the system to place advertisements. Which advertisement gets placed and the rotation of those advertisements may be based on many factors including date, time, user IP address, technology in the technology highlight section 1220, the technology that was last being viewed by the user, as well as cost. The screen 1200 also provides a get connected window 1260 to enable users to learn about the services and functionality of the technology portal and initiate steps to use those services and functionality. The services and functionality include the ability to claim a patent as yours, to pursue technology marketing, to find technology writing services, to be added to the available technology catalog as well as to submit technology stories or become a site sponsor or advertiser.

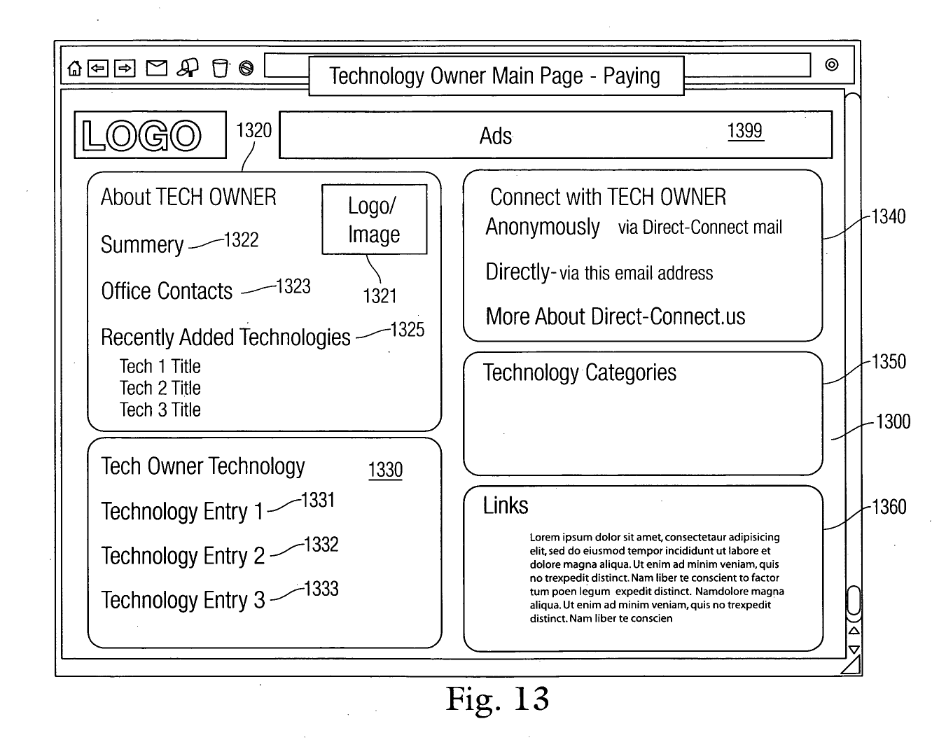

The technology portal also provides each technology owner their own main page as seen in FIG. 13. FIG. 13 provides an illustrative screen capture 1300 of a technology owner's main page. The screen 1300 provides an about window 1320 with a place for an image or logo 1321, summary information 1322 on the technology owner, the contacts 1323 within the technology owner, and recently added technologies 1325. The technology owner may provide descriptions and write ups of technology through technology entries 1331, 1332, 1333 in window 1330. The entries 1331, 1332, and 1333 would likely include summary descriptions which are also active links to more detailed technology write ups. The screen 1300 also provides a connection window 1340 enabling users to connect with the technology owner directly via-email or anonymously through the system of the present invention. The present invention provides a tool enabling users to contact technology owners while masking their e-mail or identify. The system may merely scramble names and e-mail addresses in conjunction with a key or, as utilized in the preferred embodiment, employ a message based system or creating a temporary user name associated with a real user account for the short term communication. The system could also employ a service component having a mediator act as the moderator between the parties. Anonymous connections can be important in creating licensing connections as it's a way for parties to express interest and find out information about licensing the technology without revealing themselves which can often unnecessarily increase the licensing or sale rate.

The screen 1300 also provides a technology categories window 1350 which provides a categorized break down of the technology owner's technology. Finally, the screen 1360 may provide a links window 1360 which provides active links to other websites or pages the technology owners wants to highlight. These links may be to the technology owner's licensing page hosted by their server 175, saved folders of their patents, or to other relevant links. Once again, the technology owner's main page 1300 may have one or more ad blocks 1599.

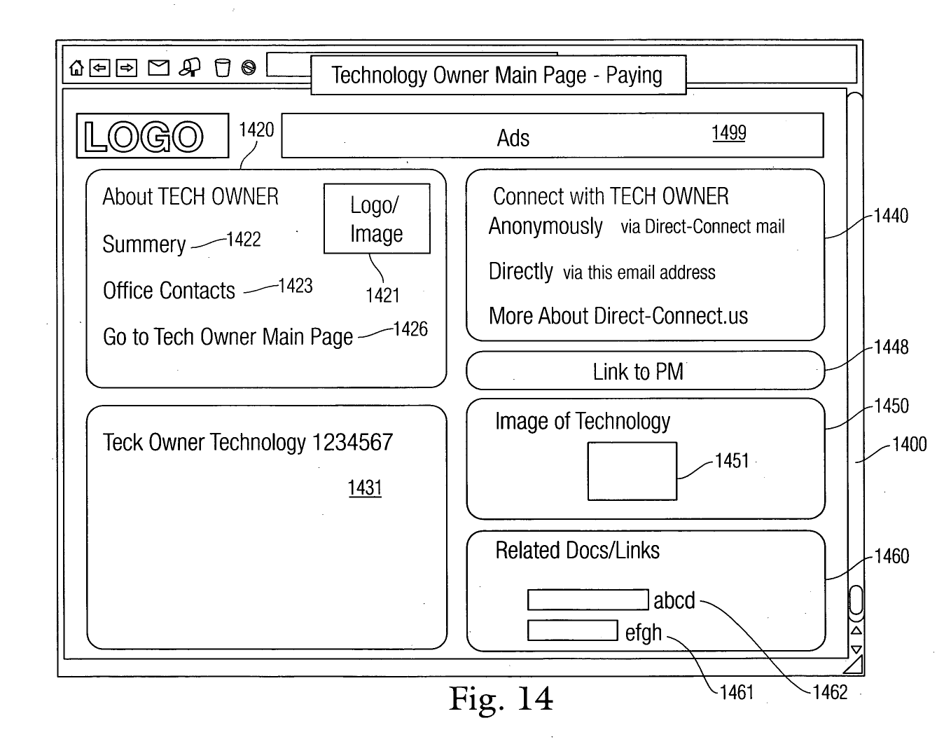

In addition to the technology owner main page 1300, each technology within the system has its own technology page as can be seen in FIG. 14. FIG. 14 provides an illustrative screen capture 1400 of the technology owner's technology page. The screen 1400 provides an about window 1420 with a place for an image or logo 1421, summary information 1422 on the technology owner, the contacts 1423 within the technology owner, and a link 1426 to the technology owners' main page. A full technology write up may be provided in window 1431. In the event that the technology owner has not prepared a technology write up information or text, such as an abstract, from a related patent may be placed in the description window 1431. Further, the technology may have one or more images 1451 associated with it which can be uploaded to the system and displayed in window 1450. The technology may have associated docs or links as listed in window 1460. The docs or links may include pdfs of the patents related to the technology 1461, published articles 1462, term sheets, or other information and links. The screen 1400 also provides the connection window 1440 enabling users to connect with the technology owner directly via-email or anonymously through the system of the present invention. The technology owner has the option to link each technology with a particular point of contact. Therefore, all leads and inquiries can be directed to the appropriate person or point of contact. Some technology owner's may also employ services others or 3^{rd} parties to review, screen and facilitate inquires and leads prior to connection to the internal point of contact for the technology owner. The screen 1400 can also provide window 1448 with links to any or all associated detailed patent pages or a folder containing the patents. Again, the screen 1400 may contain one or more ad blocks 1499.

The technology portal and platform of the present invention enable technology owner's the ability to market their technology directly to users when users are already focused on reviewing and searching technology, during a patent search. The system also allows for available technology to be searched separate and independent of patents. Technology owners are able to create one or more personalized pages 1300 for their organization or business unit within their organization as well as personalized pages 1400 for each technology. Each technology can be linked for direct connection to a particular individual within or external to the technology owner and users may make direct contact or may contact anonymously through the system. Through this system, technology owners can highlight and place their technologies in the best light to generate licensing and opportunity leads.

Further, technology owners can use the marketing platform of the system and have ads placed in the various ad blocks 590, 1399, 1350 and others on web pages as users use the system. The ads can be based on search terms so that users searching patents on a particular technology (i.e. portable power) might have ads displayed from one or more technology owners who have available and related technology (i.e. battery recharging and battery pack technologies). The system also groups technologies into categories so users can browse available and related technology and the technologies can be marketed on a broader scale such as through other sites available on the word wide web, through direct mailings, e-mail, as well as trade shows and the like. Moreover, this system can be expanded to provide marketing onto related patent search and technology sites to broadcast market the technologies available based on key search terms similar to those envisioned above via the use of existing ad platforms or through “widgets” on appropriate websites or networks.

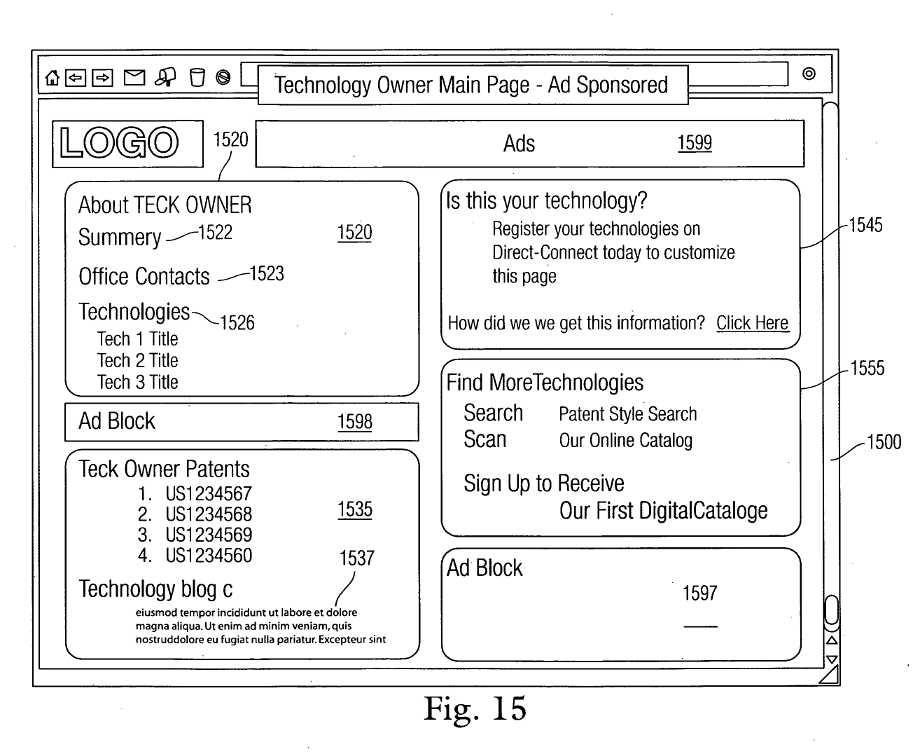

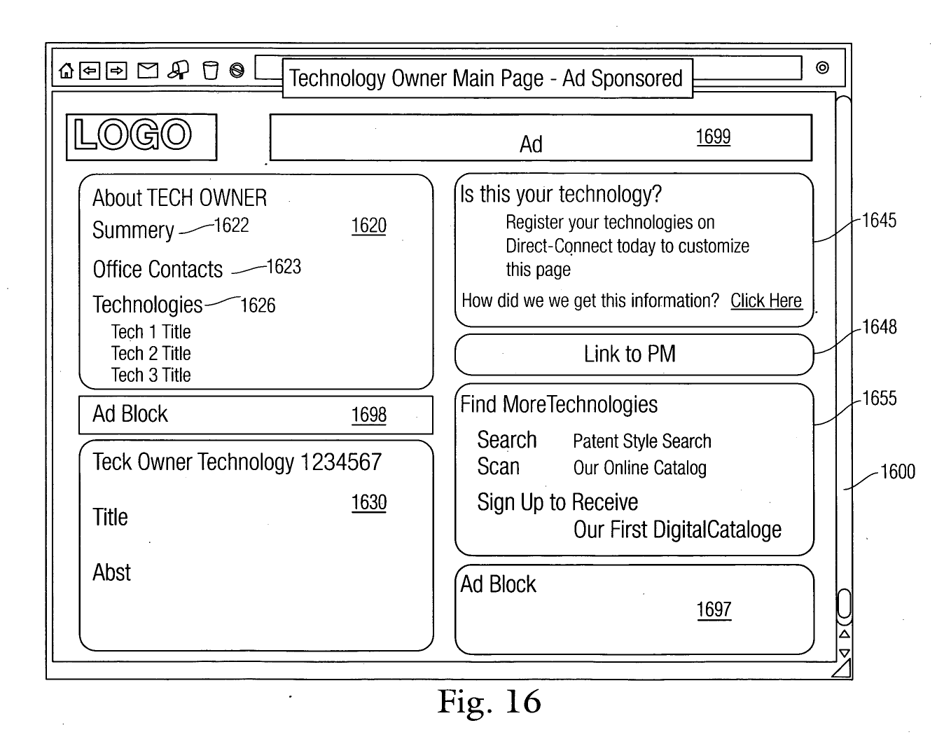

FIGS. 13 and 14 illustrate screen captures 1300, 1400 for technology owners who want a personalized page and content. However, the system does not require technology owners to sign up or create personalized pages to be in the system. The system can also pull information on technology owners or have information entered. As seen in FIGS. 15 and 16, the system provides technology owner main pages 1500 and technology pages 1600. However, the pages may have more ad blocks 1597, 1598, 1599, 1697, 1698, 1699 and connections, in the preferred embodiment, are directed to an administrator of the system (or a programmatic function controlled by the administrator), who then contacts the technology owner with the inquiry. The administrator can also use the inquiry as an opportunity to have the technology owner register with the system or to sell the inquiry lead information. The system may provide the connection directly to the technology owner without involving an administrator.

FIG. 15 provides an illustrative screen capture 1500 of a technology owner main page for an unregistered technology owner which provides information about the technology owner displayed in window 1520. The information may contain summary information 1522, contacts 1523, and technologies owned by that technology owner 1526. A list of the technology owner's patents will be displayed in window 1535 as well as any linked blogs or write ups in window 1537 the system may feed in such as through the use of RSS feeds. A claim your technology window 1545 is provided which enables a technology owner to register with the system and link their technologies. The screen 1500 also provides users a window 1555 which provides links for users to perform a search or scan a catalog of available technologies.

FIG. 16 provides an illustrative screen capture 1600 of a technology page for an unregistered technology owner. Again the page 1600 provides information about the technology owner in window 1620 and may contain summary information 1622, office contacts 1623, and a list of technologies 1623. The listed contacts 1623 may be a link to an inquiry form fill which leads to an administrator of the system. Since an unregistered technology owner will not have provided a technology write up, the system can republish the title and abstract (as well as other information) of the related one or mote patents in window 1630. The screen 1600 also provides a claim your technology window 1645 which enables a technology owner to register, personalize their main page 1600 and their technology page 1600 and link their technologies. The screen 1600 also provides users a window 1655 which provides links for users to perform a search or scan a catalog of available technologies. The screen 1600 can also provide a window 1648 which provides links to related patent detail pages or a folder of related patent pages.

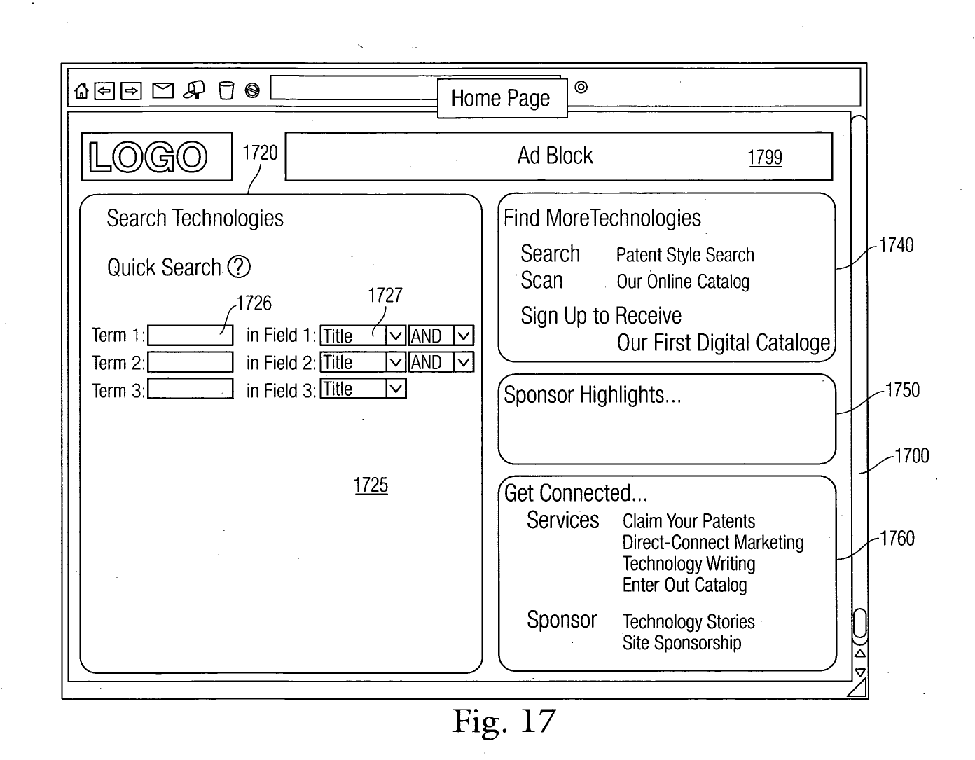

FIG. 17 provides an illustrative screen capture 1700 of the search function of the technology portal. A search window 1725 is provided which enables users to enter search terms in entry box 1726 and select the field which the term is in from drop down menu 1727. Additional terms and fields can be added to the search query. The search field 1727 includes an all fields search so that all available technologies related to the term are identified and listed. Additional searches can also be employed. The screen 1700 also provides users a window 1740 which provides links for users to perform a search or scan a catalog of available technologies. The screen 1700 also provides a get connected window 1760 to enable users to learn about the services and functionality of the technology portal and initiate steps to use those services and functionality. The services and functionality include the ability to claim a patent as yours, to pursue technology marketing, to find technology writing services, to be added to the available technology catalog as well as to submit technology stories or become a site sponsor or advertiser.

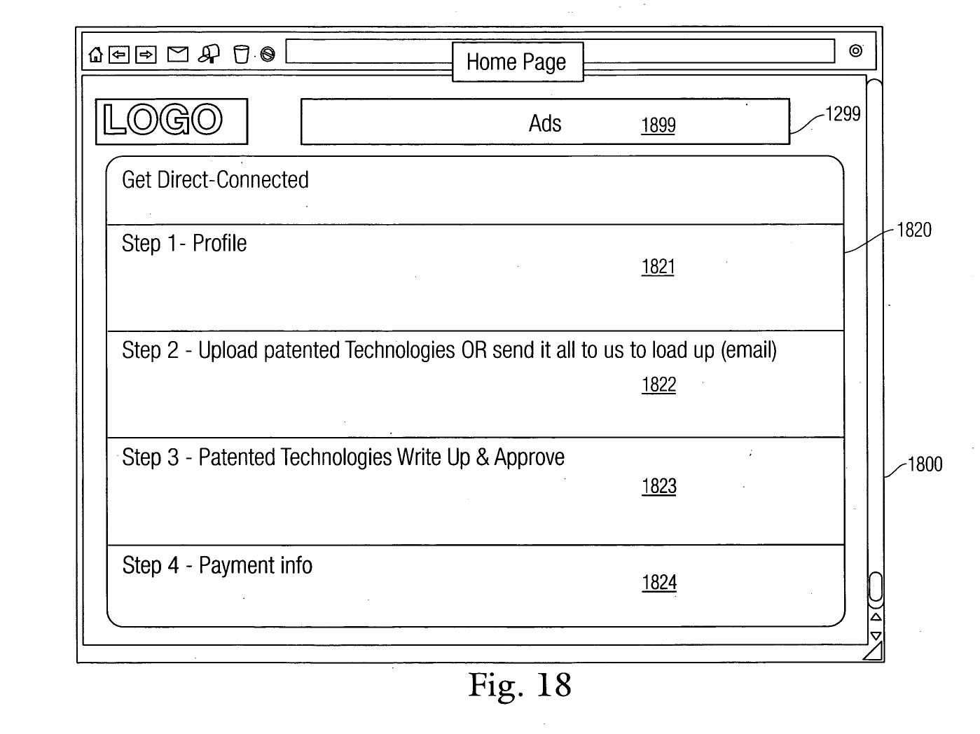

FIG. 18 provides an illustrative screen capture 1800 of a technology owner registration and customization page. The page 1800 provides an information window 1820 for the technology owner to enter profile and contact information 1821, upload or list patented and available technologies 1822, provide technology write ups 1823 and enter any payment information 1824 associated with the account for purchasing marketing, technology write up services, page customizations and other products or services. The page 1800 may have ad supported banners 1899.

Once of the benefits of the system is that the number of times a user views a technology owner's patent detail page, downloads a patent, views the technology write up page, and view the technology owner's main page can be tracked, stored and reported. This assists technology owner's identify technologies of interest and determine where they should spend their time and resources to generate more leads and close more deals. This information can also be added as additional user-generated actions combined with other search algorithm methods as detailed above.

As many companies have adopted ‘open innovation’ strategies which incorporate allowing other companies access to their technologies through license arrangements the need for those companies to inform the technology community about available technology, to market and generate leads is increasing. However, traditional web postings of isolated and disconnected sites and technology are inefficient and don't touch technology seekers in their normal activities. Combining the marketing of technology and ability to connect with technology owners when technology seekers are conducting their normal technology research and related activities provides the most opportune time to generate licensing leads. The present invention provides a web or networked patent search software application, system and method that incorporates the ability for users to search patent documents with the added ability to view patents and technology available for licensing, including within the search results, to initiate communications with the technology owners or to learn more about a technology or patent, its inventor(s), assignee, patent attorney/law firm as well as any other entity or person as named on the patent.

The system of the present invention employs a number of methods for linking and connecting technology owners and technology seekers as well as service providers and service seekers, including: (1) creating contact links (e.g. linkable text, buttons next to the name) directly to people or entities as listed in a patent through a communication system within the website or networked system; (2) creating contact links to a profile or information pages which can allow for the integration or referral to external profile or content via XML or web links; (3) use of sponsored inserts in conjunction with a patent, technology search results area or user profile information, where such advertising inserts are either inserted text into a search results or as separate modules on a page which would link to additional information; (4) use of a profile or links to as used for employment referral material either through the creation of a profile or as one or a series of links to other websites or networks of personal information for hiring or credential verification; and use of referral information on other suppliers or content providers to enhance their website product or content offering, either by re-posting licensing and contact information/availability from the data available from this system or through a direct links via network, XML, FTP or batch data transfer and updating techniques.

Advertisers and sponsors obtain marketing services on the system through a pay-per-view, pay-per-click, or pay on performance (e.g. upon a successful license of a technology, signing on of a new client). The use of user profile information, IP address, or search terms or relevant words on a page allow advertisers to select a targeted audience to send their marketing message to, either by ad blocks, email, mail, and/or throughout the website. Interested advertisers could also have the option to be notified of a certain profile's interest in a patent, technology area, set of search terms or tags or other user identifying means in conjunction with profile information to trigger a marketing message or website ad display.

The system of the present invention is particularly useful for companies or individuals looking to license their technology. Through the system of the present invention, patent holders can identify their patents as available (or not available) for license or sale. As users conduct searches and review the results they will be able to see patents which are available for licensing. The patents available will be displayed in conjunction with the user's search results so that patents available for licensing (or sale) are highlighted or flagged within the search results.

However, patents which are not within the search result, but which are related to the technology of the search request could also be displayed such as in ad blocks or sponsored windows. Related patents might include patents related in technology, alternative technologies, industry related technologies, technologies which are an addition or enhancement to that being searched, or underlying technology or technology related to a component of the primary technology or product being searched (i.e. battery charging technology for portable products).

In addition to identifying patents available for license or purchase, the system also provides technology owner's the ability to provide specific information about the patents or technology available for license. Such information might include the terms or licensing, royalty rate, license fee, territories, categories, as well as contact information to initiate discussions.

The system could also be used to provide information on inventors, law firms, patent examiners, license brokers, and other parties involved in the intellectual property space. Interested constituents could create linked content pages within the system which provide information and links from patent detail pages when their name is referenced. The links could take the user to a website owned and/or managed by the inventor, firm, broker, or other individual or entity or it could take you to a page within the system. In the preferred embodiment, the pages are modifiable pages allowing the inventor, attorney, firm or broker to adapt and create a personalized page. Such a system would allow each technology owner, attorney, inventor, firm, broker, or other party to create their personalized page for others to see and learn about them, their services, or their patent. Moreover, administrators of the system can pre-populate information about these different people or organizations using patent text and image data available from the system.

Another aspect of the present invention is the ability to provide term sheets, contracts, and other documents for parties to use for their discussions. One method to reduce the negotiation process for parties to enter into license agreement is to provide either: (1) a uniform set of terms that all parties agree to; or (2) load up the set terms and contracts of the technology owner who is making their technology available. Therefore, if parties are contacting each other, publicly or anonymously, the patent holder's contract terms or term sheets would be publicly available or easily accessible for review. However, as some parties would prefer to resolve all contract discussions quickly, a uniform contract or set of terms can be provided allowing all parties in the system to agree to one set of standard terms such that only one or a few terms need to be negotiated. Such contracts and/or terms may be provided for license agreements, patent or technology sales, assignment agreements, services contracts, non-disclosure agreements, and other applicable agreements.

Dynamic Status Determination and Relevancy Adjustment

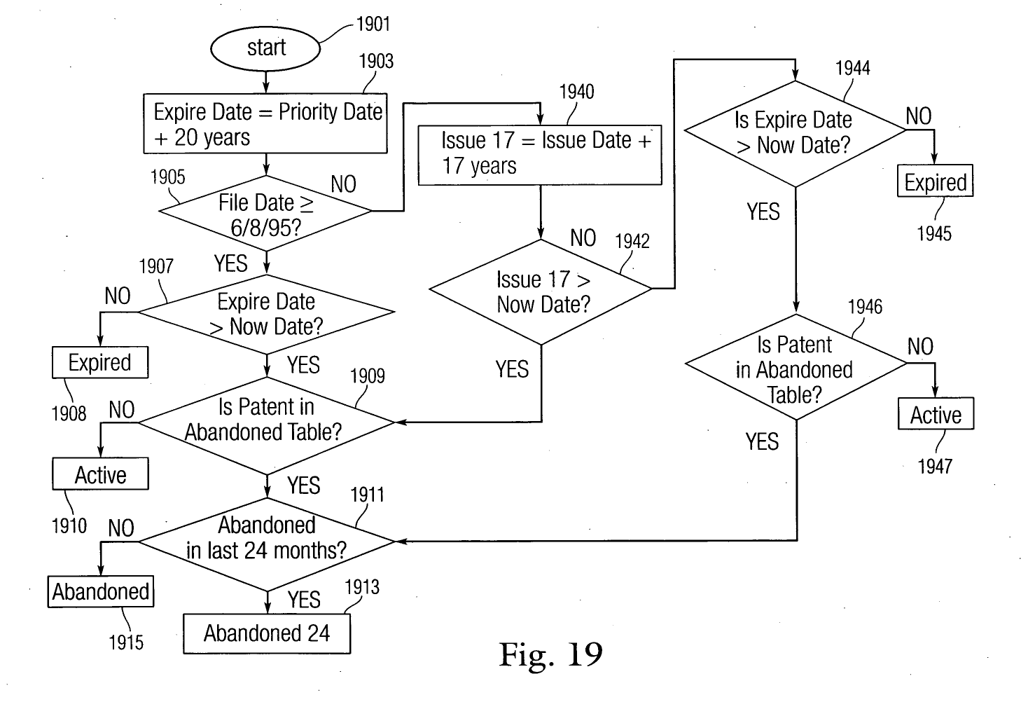

The system of the present invention also determines the status of each individual patent within the system and displays such information on the patent detail page. The status information is more specifically described in conjunction with FIG. 19-23 which depict various flow diagrams for determining patent status as well as using the patent status for ranking or scoring patents as well as assessments and valuation purposes.

As seen in FIG. 19, the preferred embodiment provides a system for dynamically determining the status of a patent. The process or method includes initiating or starting the process in step 1901 when a patent detail page is being called or when creating a search results, folder or other list. For US patents the method includes setting the Expiration Date as the priority date plus 20 years in step 1903. In step 1905 the system determines if the Filing date or File Date is greater than or equal to Jun. 8, 1995. If yes, then in step 1907 the system determines if the Expiration Date is greater than the Now Date or current date. If no, then the patent is expired and the “expired” status is displayed in step 1908. If yes, then in step 1909 the system determines if the patent exists in the patent abandoned table within the database. If no, then the patent is active and the “active” status is displayed in step 1910. If yes, then in step 1911 the system determines if the patent has been abandoned within the last twenty four (24) months. If yes, then in step 1913 the patent is set to Abandoned 24 and “Abandoned 24” is displayed. If no, then in step 1915 the patent is set to Abandoned and “abandoned” is displayed. Abandoned 24 is an additional status to identify that the patent has been abandoned but is still within the window that it could be revived for an unintentional delay. The abandoned 24 status is not required and the system could simply set all patents in the abandoned table to an abandoned status.

If in step 1905 the File Date is not greater than or equal to Jun. 8, 1995 then in step 1940 the system sets Issue17 date equal to the Issue Date plus seventeen (17) years. The system then, in step 1942, determines if the Issue 17 Date is greater than Now Date or current date. If yes, the system flows back to step 1909. If no, the system then determines, in step 1944, if the Expire Date is greater than the Now Date or current date. If no, then the patent status is set to expired and “expired” is displayed in step 1945. If yes, then the system determines, step 1946, if the patent is in the abandoned table. If no, the patent status is set to active and “active” is displayed in step 1947. IF yes, then the system flows back to step 1911.

The system also employs a method for adjusting the relevancy or score of a patent based on its status. Similar to the dynamic status determination discussed in conjunction with FIG. 19, the status relevancy adjustment or scoring is determined.

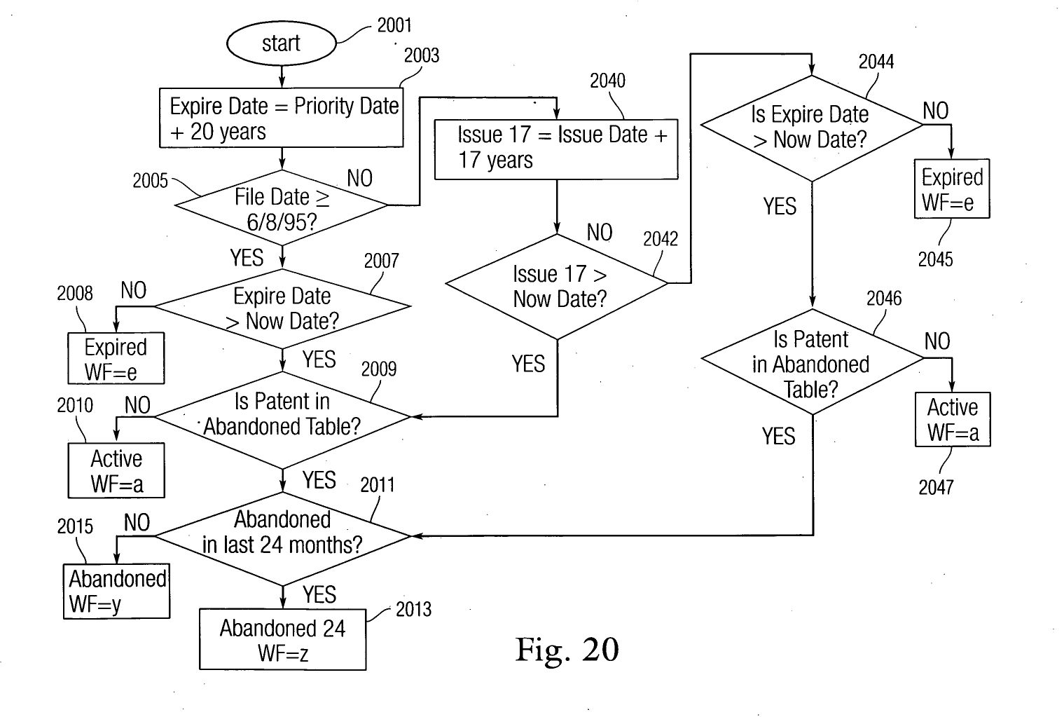

As seen in FIG. 20, the process or method includes initiating or starting the process in step 2001 when a patent detail page is being called or when creating a search results, folder or other list. For US patents the method includes-setting the Expiration Date as the priority date plus 20 years in step 2003. In step 2005 the system determines if the Filing date is greater than or equal to Jun. 8, 1995. If yes, then in step 2007 the system determines if the Expiration Date is greater than the Now Date or current date. If no, then the patent is expired and a weighting factor “WF” for the patent is set to a value “e” used by the scoring and relevancy algorithms in step 2008. If yes, then in step 2009 the system determines if the patent exists in the patent abandoned table within the database. If no, then the patent is and a weighting factor “WF” for the patent is set to a value “a” used by the scoring and relevancy algorithms in step 2010. If yes, then in step 2011 the system determines if the patent has been abandoned within the last twenty four (24) months. If yes, then in step 2013 the patent is set to Abandoned 24 and a weighting factor “WF” for the patent is set to a value “z” used by the scoring and relevancy algorithms in step 2013. If no, then in step 2015 the patent is set to Abandoned and a weighting factor “WF” for the patent is set to a value “y” used by the scoring and relevancy algorithms in step 2015.

If in step 2005 the Field Date is not greater than or equal to Jun. 8, 1995 then in step 2040 the system sets Issue17 date equal to the Issue Date plus seventeen (17) years. The system then, in step 2042, determines if the Issue 17 Date is greater than Now Date or current date. If yes, the system flows back to step 2009. If no, the system then determines, in step 2044, if the Expire Date is greater than the Now Date or current date. If no, then the patent status is set to Expired and a weighting factor “WF” for the patent is set to a value “e” used by the scoring and relevancy algorithms in step 2045. If yes, then the system determines, step 2046, if the patent is in the abandoned table. If no, the patent status is set to active and a weighting factor “WF” for the patent is set to a value “a” used by the scoring and relevancy algorithms in step 2047. If yes, then the system flows back to step 2011.

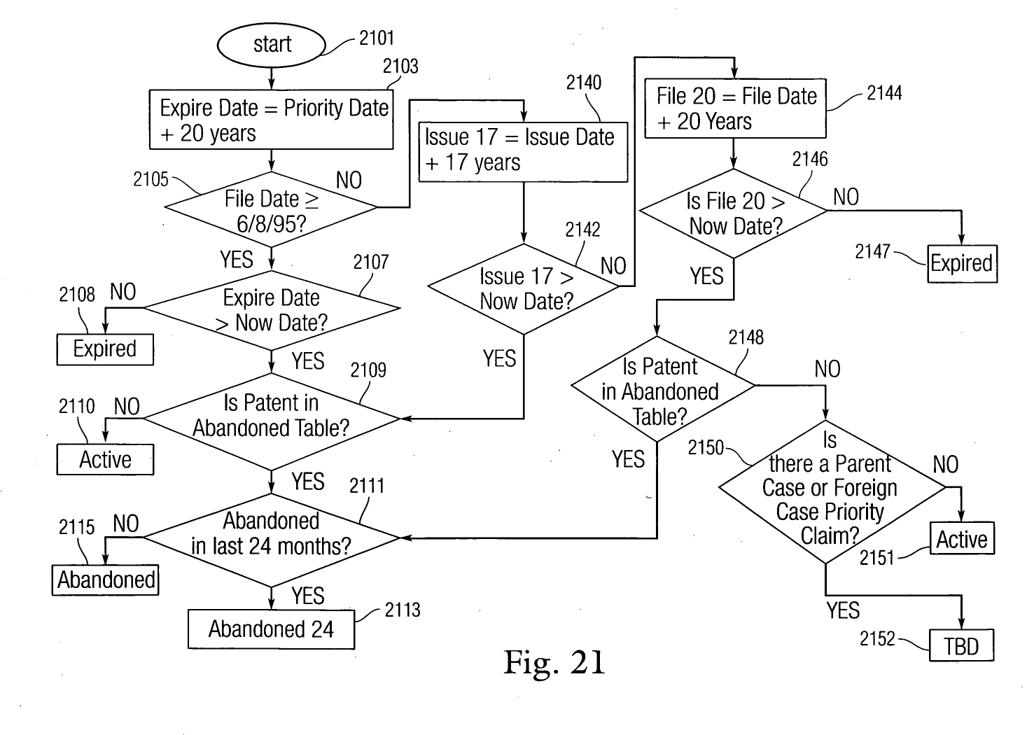

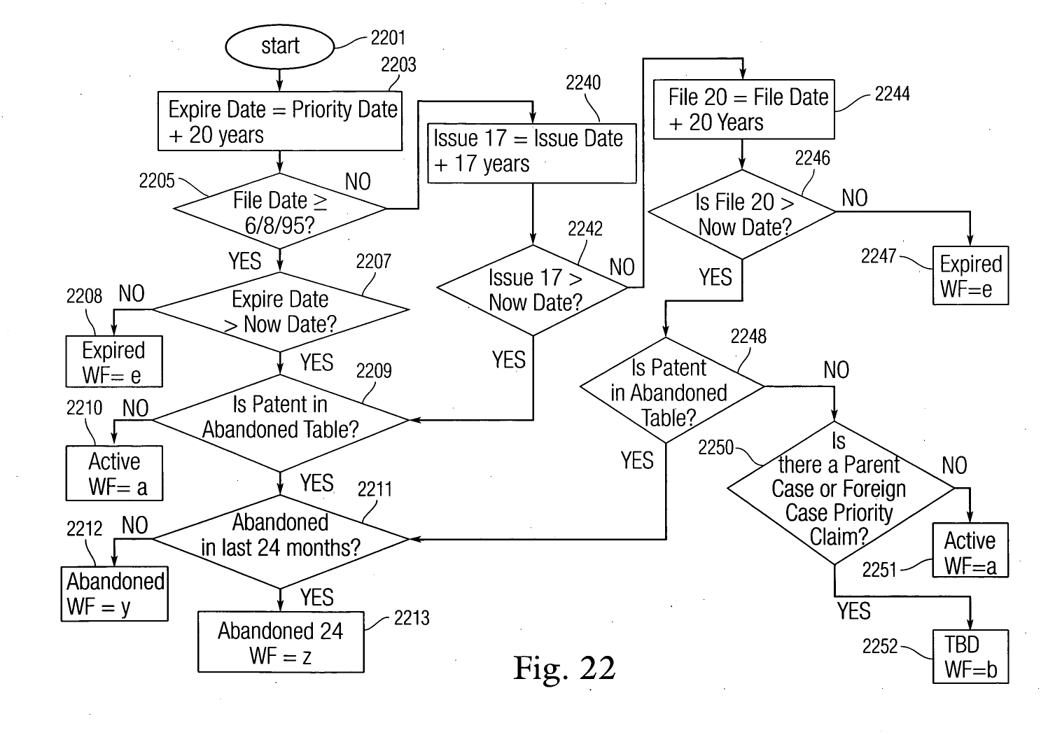

FIGS. 21 and 22 illustrate an alternative method and flow which incorporates the use of additional priority date to determine status and relevancy or score adjustment.

As seen in FIG. 21, the process or method includes initiating or starting the process in step 2101 when a patent detail page is being called or when creating a search results, folder or other list. For US patents the method includes setting the Expiration Date as the priority date plus 20 years in step 2103. In step 2105 the system determines if the Filing date is greater than or equal to Jun. 8, 1995. If yes, then in step 2107 the system determines if the Expiration Date is greater than the Now Date or current date. If no, then the patent is expired and the “expired” status is displayed in step 2108. If yes, then in step 2109 the system determines if the patent exists in the patent abandoned table within the database. If no, then the patent is active and the “active” status is displayed in step 2110. If yes, then in step 2111 the system determines if the patent has been abandoned within the last twenty four (24) months. If yes, then in step 2113 the patent is set to Abandoned 24 and “Abandoned 24” is displayed. If no, then in step 2115 the patent is set to Abandoned and “abandoned” is displayed.

If in step 2105 the File Date is not greater than or equal to Jun. 8, 1995 then in step 2140 the system sets Issue17 Date is set to equal the Issue Date plus seventeen (17) years. The system then, in step 2142, determines if the Issue 17 Date is greater than Now Date or current date. If yes, the system flows back to step 2109. If no, the system then sets, in step 2144, the File 20 Date to the File Date plus twenty (20) years. The system then determines, in step 2146, if the File 20 Date is greater than the Now Date or current date. If no, then the patent status is set to Expired and “expired” is displayed in step 2147. If yes, then the system determines, in step 2148, if the patent is in the abandoned table. If yes, then the system flows back to step 2111. If no, then the system, in step 2150, determines if there is a Parent Case or Foreign Priority claim. If no then patent status is set to active and “active” is displayed in step 2151. If yes, then the patent status is set to “TBD” and “TBD” is displayed in step 2152. The status TBD stands for “to be determined” and is a call out to the user to manually determine the expiration date. Moreover, the exact expiration date of each patent, including those with priority claims, can be determined and entered into a look-up table or database to more accurately determine the status of each patent without identifying a patent as TBD.

Again the system can also use the status to adjust the relevancy or score of a patent. As seen in FIG. 22, the process or method includes initiating or starting the process in step 2201 when a patent detail page is being called or when creating a search results, folder or other list. For US patents the method includes setting the Expiration Date as the priority date plus 20 years in step 2203. In step 2205 the system determines if the Filing date is greater than or equal to Jun. 8, 1995. If yes, then in step 2207 the system determines if the Expiration Date is greater than the Now Date or current date. If no, then the patent is expired and a weighting factor “WF” for the patent is set to a value “e” used by the scoring and relevancy algorithms in step 2208. If yes, then in step 2209 the system determines if the patent exists in the patent abandoned table within the database. If no, then the patent is active and a weighting factor “WF” for the patent is set to a value “a” used by the scoring and relevancy algorithms in step 2210. If yes, then in step 2211 the system determines if the patent has been abandoned within the last twenty four (24) months. If yes, then in step 2213 the patent is set to Abandoned 24 and a weighting factor “WF” for the patent is set to a value “z” used by the scoring and relevancy algorithms. If no, then in step 2215 the patent is set to Abandoned and a weighting factor “WF” for the patent is set to a value “y” used by the scoring and relevancy algorithms.

If in step 2205 the File Date is not greater than or equal to Jun. 8, 1995 then in step 2240 the system sets Issue17 Date equal to the Issue Date plus seventeen (17) years. The system then, in step 2242, determines if the Issue 17 Date is greater than Now Date or current date. If yes, the system flows back to step 2209. If no, the system then sets, in step 2244, the File 20 Date to the File Date plus twenty (20) years. The system then determines, in step 2246, if the File 20 Date is greater than the Now Date or current date. If no, then the patent status is set to Expired and a weighting factor “WF” for the patent is set to a value “e” used by the scoring and relevancy algorithms in step 2247. If yes, then the system determines, in step 2248, if the patent is in the abandoned table. If yes, then the system flows back to step 2211. If no, then the system, in step 2250, determines if there is a Parent Case or Foreign Priority claim. If no then patent status is set to active and a weighting factor “WF” for the patent is set to a value “a” used by the scoring and relevancy algorithms in step 2251. If yes, then the patent status is set to “TBD” and a weighting factor “WF” for the patent is set to a value “b” used by the scoring and relevancy algorithms in step 2252.

The weighting factors or “WF” in their most simplistic form are decimal numbers which are multiplied by the known score or relevancy ranking of each patent obtained from text or semantic analysis or the systems other scoring and relevancy methods described above which incorporate user actions and data. For example, the weighting factor for an abandoned patent might be 0.9 such that the abandoned patents lost ten percent of their relevancy ranking. The various weighting factors, a, b, e, y, and z can be adjusted and tested with the scoring and relevancy ranking algorithms to provide optimized relevancy and/or scoring values. The values and weighting factors could vary according to the type of search the user is conducting. A novelty search might have different weighting factors than a search for a freedom to operate or clearance search.

Search Relevancy Factors

The system makes use of various data elements to determine relevancy ranking of the patents within a search result. Such data elements include the status of a patent (i.e. active, abandoned, expired), whether the patent is available for license or sale, whether patents are in the same family, are referenced by, cited by, patents most downloaded or added to folders, and other factors. Through the use of word relevancy in particular fields, word count of the key words in various fields, the number of patents which reference the patent, the number of downloads and/or adds to folders, the status, and other factors can all be incorporated and factored into the process for determining relevancy of a particular patent in relation to other patents found in the same keyword search.

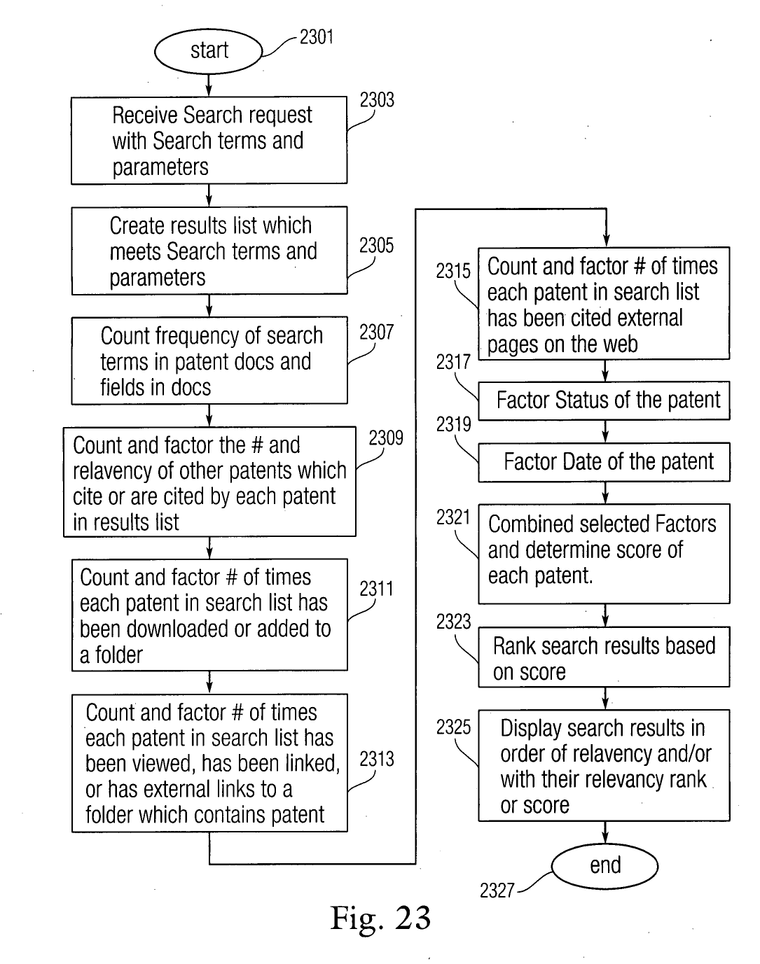

As seen in FIG. 23, a method for determining the relevancy of documents within a search result is determined. The process is initiated in step 2301 when a user enters a search query. In step 2303, the system receives the search request with search terms and the various search parameters. In step 2305 the system creates a results list from the patent text word tables and/or patent text data which meets the search terms and parameters. The system can conduct a count of the search terms in each patent document and field in the patent document in step 2307. In step 2309, the systems counts and factors in the number and relevancy of other patents which cite or are referenced by each patent in the results list. In step 2311, the system counts and factors the number of times each patent in the search list has been downloaded and/or added to a folder. In step 2313, the system counts and factors the number of times each patent in the search list has been viewed, linked, or is within folders linked. In step 2315, the system counts and factors the number of times each patent in the search list has been cited on external web pages on the web. In step 2317 the system factors in the status of the patent such as through use of the weighting factor. In step 2319 the system factors in the date of the patent. In step 2321, the system combines the selected factors and determines a score for each patent in the search results list. In step 2323 the system ranks the patents in the search results list based on the score or relevancy adjustment. In step 2325, the system displays the search results in order of relevancy and/or with their relevancy rank or score visible. The process or method is ended in step 2327. The method could employ all or some of the identified step and still fall within the scope of the Relevancy adjusting method of the present invention. Further, the method could employ additional factors such as whether a patent is available for license or sale, has been upheld or invalidated during a reexamination, has been successful (or not) in any court proceedings, has been licensed, or other relevant information.

Patent to Article Meta-Tagging and Comparison

The system of the present invention also provides a Web-based platform that processes and translates patent content into its common semantic elements through the use of advanced algorithms as well as processes and translates technical journal; articles, and related publications and content into their common semantic elements. The system can systematically tag and scores each component of a patent, article, or content identifying topics, industry, organization, person, place and if any product is mentioned creating meta-tags for each document. The meta-tags of patents (which would include the date the patent was filed) can be assessed against the meta-tags of articles to provide highly relevant art to each patent. The process or analysis can also be run historically against data to find prior art and/or infringing products or licensing opportunities.

Patent APIs

The system also employs one or more application programming interfaces (API) which interface the system including its databases in order to allow requests for services or documents to be made and transmitted to or by other computer programs or devices, and/or to allow data to be exchanged between them. Several of APIs the system incorporates include a patent pdf download API, a patent search API, a patent image API, and a patent detail page link tool API.

The Patent pdf download API provides a tool that users, blog writers, and website owners can install which provides a small window interface. Users, blog readers, and 3^{rd} party website users will see the pdf download API and can enter one or more patent numbers into the window which will send a request to the system 100 to access the various databases 110, 115, 117, 120, 125 and provide pdf documents or patent detail pages of the requested patents. The system might provide the requested patent or patents as individual files, as a folder, or open windows with the pdf document or patent detail page in the window. The open window may include ad blocks or banners as well as information on if that patent is available for licensing such as license icon or window 507. The patent pdf download API provides users a quick and easy way to download patent pdf documents while still creating and effective tool for marketing and connecting available technology.

The Patent Search API would be an interface for other websites, intranets, programs or applications to embed or layer an API which would allow their users to access and conduct a patent search. In a preferred embodiment, the Patent Search API would utilize the quick search function but could use an advanced search function. The patent search API would allow a remote user on a remote website (i.e. patent discussions.org) hosted on a remote website server to enter search terms which then send a request to the system servers 105, 106 to conduct a search query. The patent website server would then send the results of the search back to the API for display on the remote website. In the preferred embodiment, the user would be able to view the search results and scroll over the results list with their mouse icon to see images of the patents (using the bubble window API discussed below). When the user clicks on one of the patents within the list or on one of the bubble window images they will be redirected to the patent detail page for that patent resident on the system servers 105, 106.

The Patent Image Bubble Window API would allow text within content made available on the web to be scanned and when scanned text was identified or associated with a patent (i.e. the patent number) it sends a request to the system of the present invention to provide a front page image (or more images) of the identified and linked patent. The active hyperlink would display an image of the front page of the patent in a pop up window when a user scrolls over the hyperlinked text. The Bubble image API would also work for other documents as well as trademarks, and copyright registrations.

Additionally, the system can provide a patent detail page link tool API which enables a blog or website owner to scan text on the blog or website and have any patent related references create active links to the corresponding patent detail page or other information, content, or image pages related to the patent contained in the system of the present invention. The API does not have to scan the text but could be used to make active links by the content provider while creating the content on their site. As an example, the blogger might type in the text “U.S. Pat. No. 1,234,567” in a certain format as a call to the API to create a hyperlink. For example, the blogger might type “<U.S. Pat. No. 1,234,567/patentmonkey>” which is a call to hyperlink the text to the one or more patent related databases of the system of the present invention. By way of a specific example, a website hosting a blog about patent related topics might reference a particular patent (i.e. U.S. Pat. No. 1,234,567). The application would scan the text of the blog and would make the text “U.S. Pat. No. 1,234,567” an active hyperlink to the URL of the patent page or image of the system (i.e. www.patentmonkey.com/pm/patentid/1234567.aspx).

Active Icons or Buttons

Another aspect of the present invention is the use of active Icons or Buttons on the WebPages and/or directly on the images of the patents on the WebPages. In addition to the License Info button 507, the active icons may include an Assignee Info button, Status Info button, patent family tree, linked patents, patents most downloaded with the patent being viewed, linked products, linked applications, file history, personal contacts (through people finder or professional web sites such as LinkedIn.com) and other related information.

The Assignee Info button would provide users information on the assignment history related or the most recent owner of record of the patent or patent application. The patent detail page may display the most recent owner of record without needing to select or clock the assignee button or link. The Status Info button would provide users information on the status of the patent or patent application which might include whether the patent is active, abandoned, revived, in an interference proceeding, or whether it is being reexamined or litigated. Additionally, the information provided to the user could also be provided directly on the patent web page and not require the user to click or select one of the icons or buttons.

Parsing of Data

Another aspect of the present invention is the ability to parse out patents or patent applications within the database or within the search results that have are abandoned or expired. When conducting clearance searches in particular, the status of a patent is important. Expired or abandoned patents are open to the public and free to use without the need for a license. Those conducting searches or clearance reviews want to know the status of patents to identify active patents which may present clearance issues. Being able to parse out portions of the database or search results enables the searcher or reviewer to focus only on those patents which are active. Users may also want to search only expired or abandoned patents to identify technology that they are free to use and copy. Users may choose to conduct full searches which include expired and abandoned patents with the status of those patents being identified on their patent detail page. The system of the present invention can also employ filters to identify patents which can still be revived and/or patents in the same family which are still active.

Product Information and Marking

Another aspect of the present invention is the incorporation of information, most likely in the form of additional linked webpages, on products and systems which employ the patented or patent pending technology. This would allow searchers, consumers, and product makers to link or relate products employing a particular technology. As an example, a patent on ambient noise reduction headphones might have an icon or button (or content directly on the patent webpage) linking to various products which employ the noise reducing technology. In the preferred embodiment, the linked webpages would be hosted on the system of the present invention for display by servers 105, 106. Still further, the links may be to product related pages supplied by the product manufacturer, a content provide that review products or provides product information, and/or a merchant website that provides product information and sells products. Linking or tying in product related information helps users identify the use of patented technology, helps product manufacturers provide notice to the user of their patented technology, supplements product patent marking, and provides opportunities to educate users on their technology and available products to increase licensing potential and/or product sales.

Integrated Auction, Sale, and Pools/Arrays

The system of the present invention also provides tools and functions enabling patent owners to sell or auction their patents while enabling user the ability to view, buy and bid on patents and patent applications. The selling, licensing, auctioning, and buying of patents is performed through a software application resident on one or more of the servers 105, 106. Patents which are available for sale or auction can be identified and flagged as available for sale or auction on the individual patent pages, on search result pages, and in special sections devoted to patents for sale or auction. The technology owner may set the auction to be conducted as an ongoing automated but live auction implementing many features such as reserves, online payment, and other like features. The auction could also be held at specified times or dates (i.e. quarterly) such that numerous patents come onto a live auction setting.

Pools/Arrays

The system of the present invention also enables patent holders with related technologies to create patent pools or arrays. Through the patent database webpage system, patents with critical or complimentary technologies can be combined or link with related icon or licensing information as well as co-marketing activities. When a user selects the License me icon for that patent they are provided information for licensing from the patent pool or array. A patent pool would grant access or a license to all patents within the pool while an array would provide access to particular patents held within a multi-party array of patents. The pools and arrays determine or establish how revenue is split amongst the patent owners.

Additional Features and Services

In addition to the functionality already described, the present invention provides the ability to integrate patent maintenance fee payment capabilities, patent docketing functionality, the integration of licensing royalty collection and audit services, and the user of secondary services such as licensing or broker representatives. The integration of patent fee payment capabilities enables users to make payments online which will be used to process payment at the Patent Office of the jurisdiction within which the patent identified is related. Registered users could be notified via e-mail when payments are due and reminders could be sent until payment is made. In addition, multiple forms of payment could be accepted online and the site would then process the necessary steps to make payment at the appropriate patent office. For those patent holders licensing their patents, ancillary collection and auditing capabilities with online reporting could be integrated. Such activities would be beneficial to patent holders with limited resources to handle the collection and auditing functions as well as the ability to see online reporting of activities. Finally, not all patent holders have the capabilities to handle the licensing and negotiations associated with patent and technology licensing. Therefore, the system could integrate and facilitate the interaction of 3^{rd} party representatives to generate, filter, screen and analyze license opportunities enabling patent holders the ability to utilize experienced professionals in the negotiation process.

Image Mapping and Searching

Another aspect of the present invention is the incorporation of image to image searching. Recent developments in image analytics have enabled image to image searching. Image to image searching uses one image as the target image and seeks out similar or related images. The system of the present invention allows for straight image to image searching or in combination with text analytics. For example, an image may be tagged or labeled with the word “gear” and the image to image search would look for all other images tagged with the word “gear” and/or would look for images of gears. The system is primarily intended for image searching solely within the data of the system (i.e. patent documents) but the image to image search could be employed to search for images available via the internet. Such a system would be useful for finding similar objects or images (i.e. patent to patent) which might have different terminology but have the same general appearance and perform the same or primary function as well as finding actual products or devices (patent to public images—products) in the market that relate to a patented technology.

In the preferred embodiment, the system conducts the image to image search by storing the images of the patent documents and selecting common points on each patent as the four corners of the image. The image is then converted and/or compressed using JPEG or some other compression technology and converted to a uniform size (i.e. 128×128 pixels). Using various image matching algorithms the images most closely resembling the target image within the database are identified and displayed. The user can then manually review the images. In addition, the images found through the image to image search could be filtered using text based analytics and/or classifications including use of the relevancy rankings.

Image to image algorithms employed by the system include HSV, black/white, wavelet, and SIFT. Each of these algorithms compares two images and offers a measure of their similarity. HSV compares hue values of two images pixel-by-pixel and then calculates the difference between hue values. The black/white algorithm converts the image to grayscale, and monochrome and then calculates the correlation coefficient between the two black and white images. The wavelet algorithm creates a unique signature for each image which is then compared to one another. The SIFT algorithm extracts local features from the image that can be used to perform matching between various views. The SIFT method then compares images based upon the Euclidian distance of the feature vectors between images. Since the SIFT method does not perform a pixel-wise match, the marking, compressing, and warping steps discussed above may not be required.

Additional algorithms and techniques could be employed to identify not-only patent image to patent image similarity, but patent image to regular image or product image matches and regular image or product image to patent image matching. In addition, the system could employ the use of similar image diagnostic techniques to filter and segregate patent images between flowcharts or business method diagrams, drawings of products, chemical strings as well as use identification methods to tag or categorize images based on the patent's text data to enhance searching by a user.

Incorporation with Intellectual Asset Management Platform or Software

Intellectual Assent Management (IAM) is, in short, the process of managing and maximizing the value of one's intellectual assets (patents, trademarks, trade secrets, copyrights, and know-how). IAM software might include the docketing or calendaring of events or important dates, the digital storage of documents, multiple access rights to those stored documents, the assignment of tasks to employees, the payment of fees, the incorporation of auto-filled forms, and other like tasks. However, IAM software has not been integrated with analytic document searching, downloading, and storage.

The system of the present invention provides significant benefits and advantages for integration with an IAM software or platform. The present invention provides a streamlined and efficient patent searching and reviewing system whereby the search results and saved patents can be automatically stored and retrieved within an IAM platform. As users conduct searches and reviews within the search and review system the queries, search results and downloaded documents can all be digitally stored within the IAM software/platform. For example, a clearance search and the results can be saved in a folder and digitally stored with the other files in the IAM system related to a given product or technology

Still further, as users store additional documents within the IAM system, the present invention can employ regular expression, or like techniques, to identify references to documents (patents) within the database. Therefore, as a user conducts a search of the patents within the database, and identifies the relevant patents for the project, the system could also identify to the user all documents within the IAM system which also reference the document (patent). This would provide users the ability to review comments and arguments already made related to a document (patent) which might save time regarding the formulation of new arguments. For most corporate clients, the IAM software/platform would be within a closed and private system. However, as patent histories are public documents, the file histories of all patents could be scanned and stored for analysis related to text (regular expression) based analytics with reference and linking back to the documents (patents). This would allow users to search and review public documents and the arguments made by other professionals (i.e. other attorneys or patent office examiners) as they are specifically related to a patent of interest.

The relevance of integrating the patent search and review system of the present invention into an IAM software or platform can easily be understood by identifying the benefits a corporate client or user might enjoy. As an example, a patent attorney within a company has a new project and through some common text based searching has found some technically relevant patents. Those patents, his search and his query string could all be digitally stored within his IAM system. Further, through analysis of internal (private) and public documents for reference to any of the identified relevant patents he could determine not only previous comments made by other internal or external attorneys of the client which are linked into the IAM software/platform, or attorneys. The company's patent attorney could then determine if anyone in his close network (i.e. an internal attorney or an attorney within a firm already working for the company) or outside of his network (an attorney at another firm but with the relevant technical experience) for proper assignment of the project and for a more efficient review of the technology. The system of the present invention would allow users to make better decision regarding assignment, finding relevant art or documents, and overall storage and relevant of all documents as they relate to the each other.

System Discussion

Further to the discussion above in conjunction with FIG. 1, the system of the present invention may employ one or more servers 105, 106, client computers 104, 170, 180, 190, 192, programs, code, and other computer related devices and applications as part of the system. In all instances, the servers 105, 106, client computers 104, 170, 180, 190, 192, and client servers 175 do not need to be in the same physical location and networked computers could mean networked across the room or across the world.

The system may employ a One to Many Servers to One to Many Clients schema in which one or many master servers 105, 106 house or have access to information that is accessible to one or many client machines 104, 170, 180, 190, 192 and or devices. These device(s) would receive data updates and either make said updates available to client machines 104, 170, 180, 190, 192 and or devices, or replicate any changes to client machines or devices.

The system might also employ a One to Many Server to One to Many Client Server(s) instead of or in addition to other schemes. The schema is the same as above, except that data is made available or replicated to one/many client based servers 175, which then feed, either locally or remotely, one/many client machines or devices 104, 170, 180, 190, 192.

Further, the system may employ many Servers 105, 106 to one or many clients 104, 170, 180, 190, 192. In this form, many servers each housing a portion, which may or may not have duplicate overlapping portions, or each housing a full replication of the data could be accessible to one/many client machines 104, 170, 180, 190, 192, devices, or servers 175. The system or systems could be controlled by hardware or software to distribute data from the appropriate location to either reduce load, bandwidth, increase speed or efficiency, or handle large sets of data.

A client system/machine 104, 170, 180, 190, 192 or device can either access the data from any of the above examples, either one document or page view at a time, in bulk for later perusal, or distributed across a network of clients, either local or non local. Clients can either request new information [Client Side Retrieval] or accept information [Server to Client(s) Push] from any of the server configurations either piecemeal or in bulk, either in real time or as a scheduled transfer or multiple transfers. The processes could be controlled either by the Server machines 105, 106 or devices, software, or client side machines 104, 170, 175, 180, 190, 192 or software, some combination of both, or using third party hardware or software.

Any missing information or data (including documents) from the servers 105, 106 or various databases, can either be acquired on a per request basis (ex: a client requests information, which is then fetched by server 105, 106 and added to the data store in the various databases, and passed onto the client.) or in bulk (i.e.: acquiring a batch of new information at one or multiple times, either manually or automatically).

In summary, the present invention provides a patent information search system comprising: at least one patent information database containing a plurality of patent images, a plurality of patent documents, a plurality of patent information data, and a plurality of technology owner contact information; at least one processor for hosting a patent search website accessible over the world wide web, wherein the patent search website has at least one search page for a non-registered user to input a search query; the at least one processor receiving the search query and processing the search query through a search of the at least one patent information database; the at least one processor transmitting a search results list to the non-registered user; wherein the search results list contains at least one patent detail page link selectable by the non-registered user and whereupon selection of at least one patent detail page the at least one processor transmits a selected patent detail page containing at least one image, a plurality of data related to the selected patent, and a patent connection link; wherein the at least one patent detail page is viewable by at least one non-registered user and is capable of being indexed by at least one search engine, and whereupon selection of the patent connection link the at least one processor transmits at least one technology licensing detail page containing a plurality of technology licensing information and a communication link for a technology owner related to the selected patent; wherein the at least technology licensing detail page is viewable by at least one non-registered user and is capable of being indexed by at least one search engine; a communication application within the patent information search system to initiate a communication with the technology owner upon selection of the communication link; and at least one ad banner on one or more of the at least one search page or at least one patent detail page, wherein one or more ads for available technology within the system are placed in the ad banner. Further, the communication may be an e-mail, a web enabled chat, or a voice communication such as a phone call or voice over internet protocol (VOIP). Further, the user may remain anonymous to the technology owner upon initiation of and during the communication.

The present invention further comprises a status unit for determining a status of the selected patent and displaying the status on at least the patent detail page. The system further comprise a relevancy unit for determining the relevancy of each patent within the search result based upon the search query and at least one of the following: number of times the patent detail page has been viewed; number of times a patent document has been downloaded, number of times a patent is cited; number of times patent detail page is hyperlinked, user generated tag words; and user generated scores. The system further comprises an ad relevancy unit for determining which available technology ad to place in the ad banner windows. Such determination is based on at least one of the following: words within the search query; words within the patent detail page; patents within the search result, patents similar to the patents within the search result, based on a user profile, or based on the user's IP address.

The present invention also provides a patent information search system comprising: at least one patent information database containing a plurality of patent images, a plurality of patent documents, a plurality of patent information data, and a plurality of technology owner contact information; at least one processor for hosting a patent search website accessible over the world wide web, wherein the patent search website has at least one search page for a user to input a search query; the at least one processor receiving the search query and processing the search query through a search of the at least one patent information database; the at least one processor transmitting a search results list to the user; wherein the search results list contains at least one patent detail page link selectable by the user and whereupon selection of at least one patent detail page the at least one processor transmits a selected patent detail page containing at least one image, a plurality of data related to the selected patent, and a patent connection link; wherein the at least one patent detail page is viewable by at least one user and is capable of being indexed by at least one search engine, and whereupon selection of the patent connection link the at least one processor transmits at least one technology licensing detail page containing a plurality of technology licensing information and a communication link for a technology owner related to the selected patent; wherein the at least technology licensing detail page is viewable by at least one user and is capable of being indexed by at least one search engine; a communication application within the patent information search system to initiate a communication with the technology owner upon selection of the communication link; and at least one ad banner on one or more of the at least one search page or at least one patent detail page, wherein one or more ads for available technology within the system are placed in the ad banner; and an ad relevancy unit for determining which available technology ad to place in the ad banner is determined by at least one of the following: words within the search query; words within the patent detail page; patents within the search result, patents similar to the patents within the search result, based on a user profile, or based on the user's IP address.

The system also further comprises: at least one patent information database containing a plurality of patent images, a plurality of patent documents, a plurality of patent information data, and a plurality of technology owner contact information; at least one processor for hosting a patent search website accessible over the world wide web, wherein the patent search website has at least one search page for a user to input a search query; the at least one processor receiving the search query and processing the search query through a search of the at least one patent information database; the at least one processor transmitting a search results list to the user; wherein the search results list contains at least one patent detail page link selectable by a user and whereupon selection of at least one patent detail page the at least one processor transmits a selected patent detail page containing a front page image of the selected patent, a plurality of data related to the selected patent, and a patent connection link; wherein the selected patent detail page is viewable by at least one non-registered user and is capable of being indexed by at least one search engine, and whereupon selection of the patent connection link the at least one processor transmits, a at least one technology licensing detail page containing a plurality of technology licensing information and a communication link for a technology owner related to the selected patent, wherein the at least one technology licensing detail page is viewable by at least one non-registered user and is capable of being indexed by at least one search engine; and a communication application within the patent information search system to initiate a communication with the technology owner upon selection of the communication link, wherein the communication is an email and the user is anonymous to the technology owner upon initiation of the communication.

The present invention also provides a method for connecting a user of a patent information search system with a technology owner comprising the steps of: providing a patent information search system with at least one search page with a first ad banner, wherein the at least one search page is accessible through the World Wide Web; receiving a search query from the at least one search page from a non-registered user of the patent information search system; processing the search query through at least one patent information database associated with the patent information search system to obtain a search result containing at least one patent detail link selectable by the non-registered user to redirect the non-registered user to a patent detail page; transmitting the search result to the user; receiving a first request from the non-registered user to access a patent detail page through the user's selection of the at least one patent detail link; processing the request through the at least one patent information database; transmitting a patent detail page containing at least one image related to the selected patent, at least one ad banner, a plurality of data related to the selected patent, and a patent connection link redirecting the user to a technology licensing page, wherein the patent detail page is viewable by at least one non-registered user and is capable of being indexed by at least one search engine; receiving a second request from the user to access the technology licensing page; processing the second request through the at least on patent information database; transmitting a technology licensing detail page containing a plurality of technology licensing information and a communication link for initiating a communication with a technology owner for the selected patent, wherein the technology licensing detail page is viewable by at least one non-registered user and is capable of being indexed by at least one search engine; receiving a third request from the user to initiate a communication with the technology owner; and initiating a communication with the technology owner.

Further, the communication may be an e-mail, a web enabled chat, or a voice communication such as a phone call or voice over internet protocol (VOIP). Further, the user may remain anonymous to the technology owner upon initiation of and during the communication. The methods may further comprise the steps of: determining the status of the selected patent; and displaying the status of the selected patent on the patent detail page. The method may include the step of delivering a front page image to the patent detail page and the front page image may be sized in the range of 55-80% of the user's display setting. More specifically, the image size may be in the range of 60-65% of the user's display setting. The image file size may be in the range of 5-500 kB, but ideally is in the range of 15-275 kB.

The system of the present invention also provides a technology marketing and licensing portal providing access to non registered users comprising: at least one server connected to the world wide web and to at least one patent and technology information database for providing direct access to a plurality of web-accessible patent detail pages each corresponding to a patent, wherein each patent detail page contains at least one image, the full text, a link to retrieve a downloadable document of the patent in standardized compression format, and a link to a technology licensing detail page for the patent, wherein the technology licensing detail page contains a plurality of licensing and contact information for contacting the patent's owner; the at least one servers also providing direct access to a search engine for receiving and processing at least one query, by a non-registered user, against the at least one patent and technology data set and transmitting a search result list with at least one link to the at least one of the patent detail page to the non-registered user; wherein the patent detail page is capable of being indexed by at least one search engine; the at least one server delivering ads in at least one ad banner window on the user accessible pages for technology identified as available within the system, wherein ads are delivered by assessing one or more of the following: user profile information, user IP address, terms use in the at least one query, words on the patent detail page, advertisements by sponsors of the portal, or advertisement delivered from an advertising network; and a technology marketing tool for a technology owner to identify at least one of the patent detail pages or the documents within the system which correspond to technology owned by the technology owner, to add a plurality of content about their technology, to market the technology to other users of the system, and to link the patent detail page and the documents to contact information of the technology owner.

While the invention has been described in detail and with reference to specific embodiments thereof, it will be apparent to those skilled in the art that various changes and modifications can be made therein without departing from the spirit and scope thereof.

We claim:

1. A patent information search system comprising:
at least one patent information database containing a plurality of patent images, a plurality of patent documents, a plurality of patent information data, and a plurality of technology owner contact information;
at least one processor for hosting a patent search website accessible over the world wide web, wherein said patent search website has at least one search page for a non-registered user to input a search query; said at least one processor receiving said search query and processing said search query through a search of said at least one patent information database; said at least one processor transmitting a search results list to said non-registered user;
wherein said search results list contains at least one patent detail page link selectable by said non-registered user and whereupon selection of at least one patent detail page said at least one processor transmits a selected patent detail page containing at least one image, a plurality of data related to said selected patent, and a patent connection link; wherein said at least one patent detail page is viewable by at least one non-registered user and is capable of being indexed by at least one search engine, and whereupon selection of said patent connection link said at least one processor transmits at least one technology licensing detail page containing a plurality of technology licensing information and a communication link for a technology owner related to said selected patent; wherein said at least technology licensing detail page is viewable by at least one non-registered user and is capable of being indexed by at least one search engine;
a communication application within said patent information search system to initiate a communication with said technology owner upon selection of said communication link; and
at least one ad banner on one or more of said at least one search page or at least one patent detail page, wherein one or more ads for available technology within said system are placed in said ad banner.

2. The system of claim 1, wherein said communication is an email.

3. The system of claim 1, wherein said communication is a web enabled chat.

4. The system of claim 1, wherein said communication is a voice communication.

5. The system of claim 1, wherein said user is anonymous to said technology owner upon initiation of said communication.

6. The system of claim 1, wherein said at least one image includes a front page image of said selected patent.

7. The system of claim 1, wherein said at least one image is sized in the range of 55-80% of the user's display setting.

8. The system of claim 1, wherein said at least one image has an image size in the range of 60-65% of the user's display setting.

9. The system of claim 1, wherein said at least one image has a file size in the range of 5-500 kB.

10. The system of claim 1, wherein said at least one image has a file size in the range of 15-275 kB.

11. The system of claim 1, further comprising a status unit for determining a status of the selected patent and displaying the status on at least the patent detail page.

12. The system of claim 1, further comprising a relevancy unit for determining the relevancy of each patent within said search result based upon the search query and at least one of the following: number of times the patent detail page has been viewed; number of times a patent document has been downloaded, number of times a patent is cited; number of times patent detail page is hyperlinked, user generated tag words; and user generated scores.

13. The system of claim 1, further comprising an ad relevancy unit for determining which available technology ad to place in said ad banner is determined by at least one of the following: words within said search query; words within said patent detail page; patents within said search result, patents similar to the patents within said search result, based on a user profile, or based on said user's IP address.

14. A patent information search system comprising:
at least one patent information database containing a plurality of patent images, a plurality of patent documents, a plurality of patent information data, and a plurality of technology owner contact information;
at least one processor for hosting a patent search website accessible over the world wide web, wherein said patent search website has at least one search page for a user to input a search query; said at least one processor receiving said search query and processing said search query through a search of said at least one patent information database; said at least one processor transmitting a search results list to said user;
wherein said search results list contains at least one patent detail page link selectable by said user and whereupon selection of at least one patent detail page said at least one processor transmits a selected patent detail page containing at least one image, a plurality of data related to said selected patent, and a patent connection link; wherein said at least one patent detail page is viewable by at least one user and is capable of being indexed by at least one search engine, and whereupon selection of said patent connection link said at least one processor transmits at least one technology licensing detail page containing a plurality of technology licensing information and a communication link for a technology owner related to said selected patent; wherein said at least technology licensing detail page is viewable by at least one user and is capable of being indexed by at least one search engine;
a communication application within said patent information search system to initiate a communication with said technology owner upon selection of said communication link; and
at least one ad banner on one or more of said at least one search page or at least one patent detail page, wherein one or more ads for available technology within said system are placed in said ad banner; and
an ad relevancy unit for determining which available technology ad to place in said ad banner is determined by at least one of the following: words within said search query; words within said patent detail page; patents within said search result, patents similar to the patents within said search result, based on a user profile, or based on said user's IP address.

15. A patent information search system comprising:
at least one patent information database containing a plurality of patent images, a plurality of patent documents, a plurality of patent information data, and a plurality of technology owner contact information;
at least one processor for hosting a patent search website accessible over the world wide web, wherein said patent search website has at least one search page for a user to input a search query; said at least one processor receiving said search query and processing said search query through a search of said at least one patent information database; said at least one processor transmitting a search results list to said user;
wherein said search results list contains at least one patent detail page link selectable by a user and whereupon selection of at least one patent detail page said at least one processor transmits a selected patent detail page containing a front page image of said selected patent, a plurality of data related to said selected patent, and a patent connection link; wherein said selected patent detail page is viewable by at least one non-registered user and is capable of being indexed by at least one search engine, and whereupon selection of said patent connection link said at least one processor transmits a at least one technology licensing detail page containing a plurality of technology licensing information and a communication link for a technology owner related to said selected patent, wherein said at least one technology licensing detail page is viewable by at least one non-registered user and is capable of being indexed by at least one search engine; and
a communication application within said patent information search system to initiate a communication with said technology owner upon selection of said communication link, wherein said communication is an email and said user is anonymous to said technology owner upon initiation of said communication.

16. A method for connecting a user of a patent information search system with a
technology owner comprising the steps of:
providing a patent information search system with at least one search page with a first ad banner, wherein the at least one search page is accessible through the World Wide Web;
receiving a search query from the at least one search page from a non-registered user of the patent information search system;
processing said search query through at least one patent information database associated with said patent information search system to obtain a search result containing at least one patent detail link selectable by said non-registered user to redirect the non-registered user to a patent detail page;
transmitting said search result to said user;
receiving a first request from said non-registered user to access a patent detail page through said user's selection of said at least one patent detail link;
processing said request through said at least one patent information database;
transmitting a patent detail page containing at least one image related to said selected patent, at least one ad banner, a plurality of data related to said selected patent, and a patent connection link redirecting the user to a technology licensing page, wherein said patent detail page is viewable by at least one non-registered user and is capable of being indexed by at least one search engine;
receiving a second request from said user to access said technology licensing page;
processing said second request through said at least on patent information database;
transmitting a technology licensing detail page containing a plurality of technology licensing information and a communication link for initiating a communication with a technology owner for the selected patent, wherein said technology licensing detail page is viewable by at least one non-registered user and is capable of being indexed by at least one search engine;
receiving a third request from said user to initiate a communication with said technology owner; and
initiating a communication with said technology owner.

17. The method of claim 16, wherein said communication is an email.

18. The method of claim 16, wherein said communication is a web enabled chat.

19. The method of claim 16, wherein said communication is a voice communication.

20. The method of claim 16, wherein said user is anonymous to said technology owner upon initiation of said communication.

21. The method of claim 16, further comprising the steps of:
determining the status of the selected patent; and
displaying the status of the selected patent on said patent detail page.

22. The method of claim 16, wherein said at least one image includes a front page image of said selected patent.

23. The system of claim 16, wherein said at least one image is sized in the range of 55-80% of the user's display setting.

24. The system of claim 16, wherein said at least one image has an image size in the range of 60-65% of the user's display setting.

25. The system of claim 16, wherein said at least one image has a file size in the range of 5-500 kB.

26. The system of claim 16, wherein said at least one image has a file size in the range of 15-275kB.

27. A technology marketing and licensing portal providing access to a non registered user comprising:
at least one server connected to the world wide web and to at least one patent and technology information database for providing direct access to a plurality of web-accessible patent detail pages each corresponding to a patent, wherein each patent detail page contains at least one image, the full text, a link to retrieve a downloadable document of said patent in standardized compression format, and a link to a technology licensing detail page for said patent, wherein said technology licensing detail page contains a plurality of licensing and contact information for contacting said patent's owner;
said at least one servers also providing direct access to a search engine for receiving and processing at least one query, by a non-registered user, against said at least one patent and technology data set and transmitting a search result list with at least one link to said at least one of said patent detail page to said non-registered user; wherein said patent detail page is capable of being indexed by at least one search engine;
said at least one server delivering ads in at least one ad banner window on said user accessible pages for technology identified as available within the system, wherein ads are delivered by assessing one or more of the following: user profile information, user IP address, terms use in said at least one query, words on said patent detail page, advertisements by sponsors of said portal, or advertisement delivered from an advertising network; and
a technology marketing tool for a technology owner to identify at least one of said patent detail pages or said documents within the system which correspond to technology owned by said technology owner, to add a plurality of content about their technology, to market said technology to other users of the system, and to link said patent detail page and said documents to contact information of said technology owner.
